(19) United States
(12) Patent Application Publication
(10) Pub. No.: US 2023/0273283 A1
(43) Pub. Date: Aug. 31, 2023

(54) POSITIONING ENHANCEMENT FOR PRECODED SIGNALS WITH DYNAMIC CONTEXT INFORMATION

(71) Applicant: KONINKLIJKE PHILIPS N.V., EINDHOVEN (NL)

(72) Inventors: Martin Kurras, Berlin (DE); Thomas Haustein, Berlin (DE); Lars Theiele, Berlin (DE); Paul Simon Holt Leather, Berlin (DE); Birendra Ghimire, Erlangen (DE); Norbert Franke, Erlangen (DE); Mohammad Alawieh, Erlangen (DE)

(21) Appl. No.: 18/020,104

(22) PCT Filed: Jul. 27, 2021
(86) PCT No.: PCT/EP2021/071038

§ 371 Date: Feb. 7, 2023

(30) Foreign Application Priority Data
Aug. 7, 2020 (EP) 20190027.1
Apr. 1, 2021 (EP) 21166593.0

(51) Int. Cl. G01S 5/02; H04W 64/00; G01S 1/02

(52) U.S. Cl. CPC G01S 5/0236; H04W 64/003; G01S 1/024; G01S 2205/008

(57) ABSTRACT

An apparatus for determining a position of an entity of a wireless communication network, the comprises a position determining processor to determine a position of a first entity (gNB, UE, IoT) in the wireless communication network using one or more position measurements between the first entity and one or more second entities (gNB, UE, IoT), each of the first and second entities comprising one or more antennas to transmit and/or receive a radio signal for the position measurement. The position determining processor is to determine the position of the first entity using a transmission reception reference point, TRRP, of the radio signal at the one or more antennas of the first entity and/or the one or more second entities.

The present invention relates to the field of wireless communication systems or networks, more specifically to the localization of user devices, like mobile terminals, in such a network. Embodiments concern positioning enhancements for precoded signals with dynamic context information.

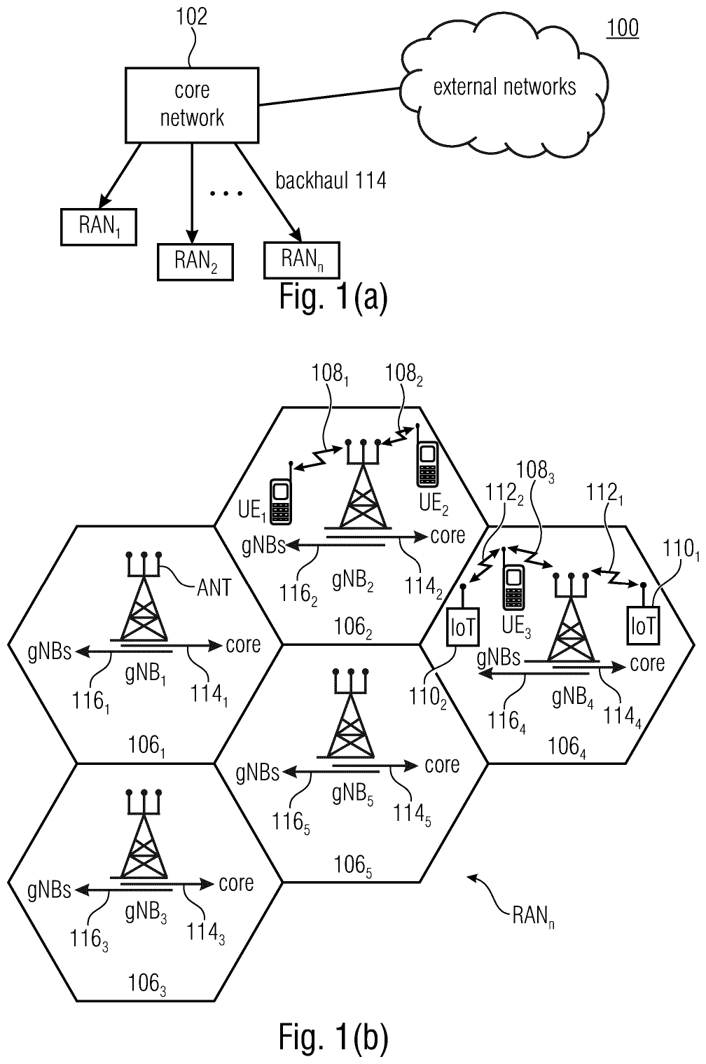

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNBs, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base stations gNB₁ to gNBs may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may support a 2-stage SCI. This refers to a first control region containing some parts of the SCI, and, optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also include of a smaller number of OFDM symbols, e.g. when utilizing a shortened transmission time interval, sTTI, or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base stations gNB₁ to gNB₆, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 1, it may be desired to locate a UE with a certain accuracy, e.g., determine a position of the UE in a cell. Several positioning approaches are known, like satellite-based positioning approaches, e.g., autonomous and assisted global navigation satellite systems, A-GNSS, such as GPS, mobile radio cellular positioning approaches, e.g., observed time difference of arrival, OTDOA, and enhanced cell ID, E-CID, or combinations thereof.

It is noted that the information in the above section is only for enhancing the understanding of the background of the invention and, therefore, it may contain information that does not form prior art that is already known to a person of ordinary skill in the art.

Starting from the above, there may be a need for improvements or enhancements with regard to the localization of an entity, like a user device, in a wireless communication system or network.

Embodiments of the present invention are now described in further detail with reference to the accompanying drawings:

FIG. 1 is a schematic representation of an example of a terrestrial wireless network;

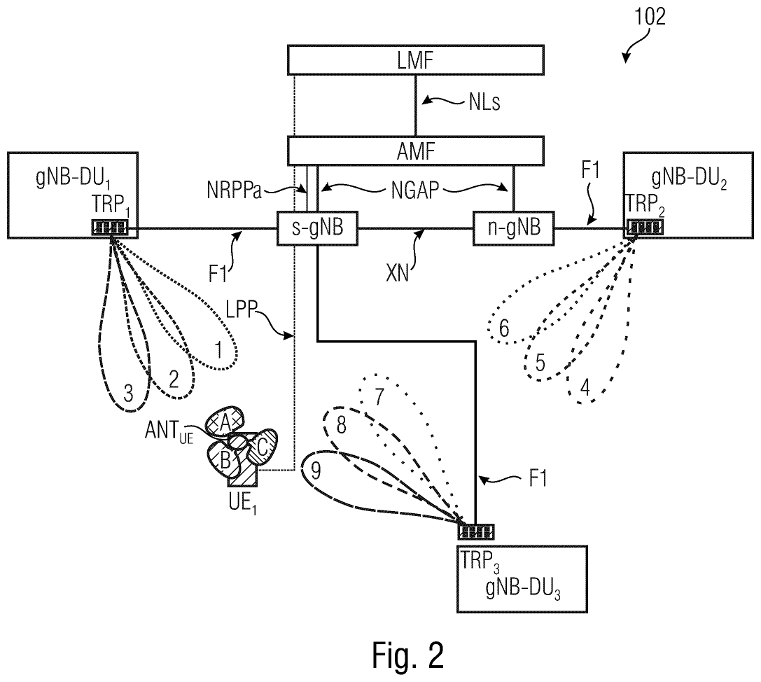

FIG. 2 illustrates the network entities involved in computing a position of a UE;

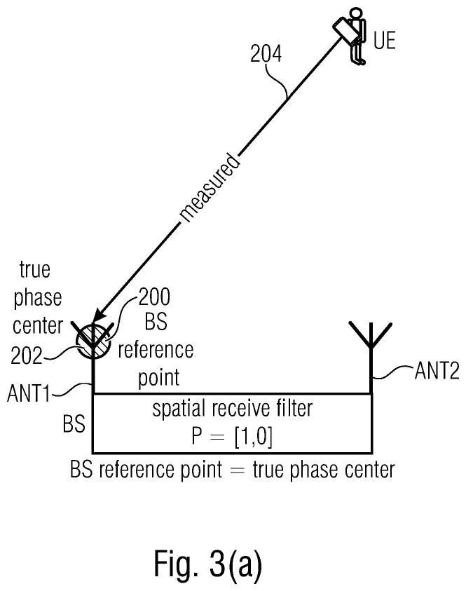

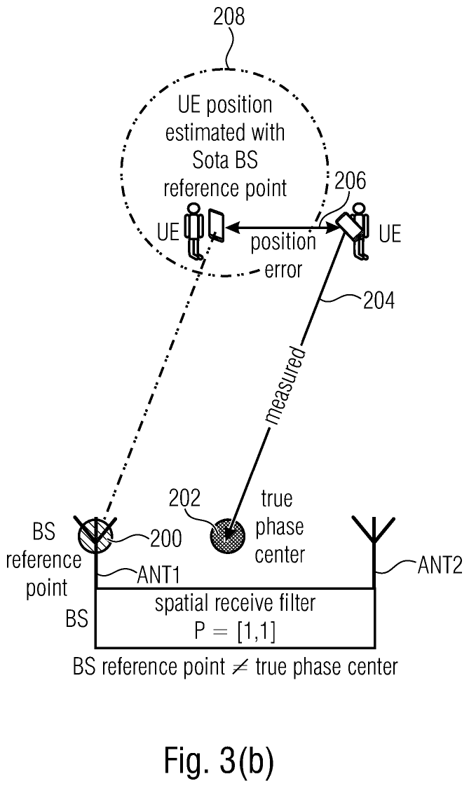

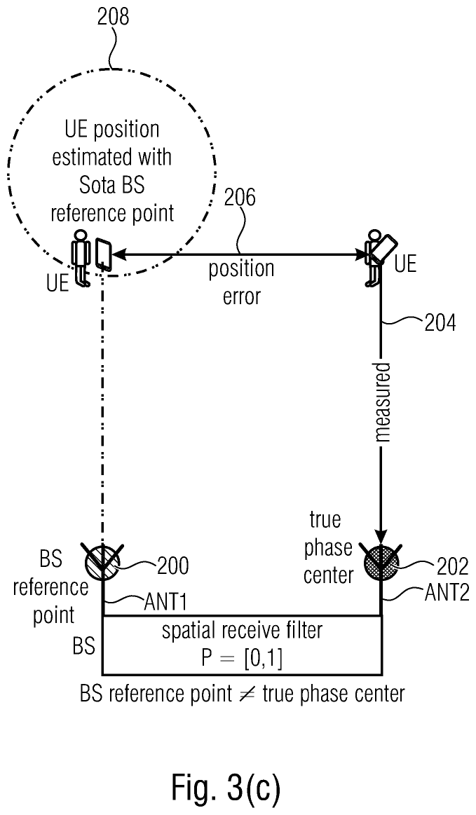

FIG. 3 illustrates a simplified example for an antenna array with two antennas and a spatial filter;

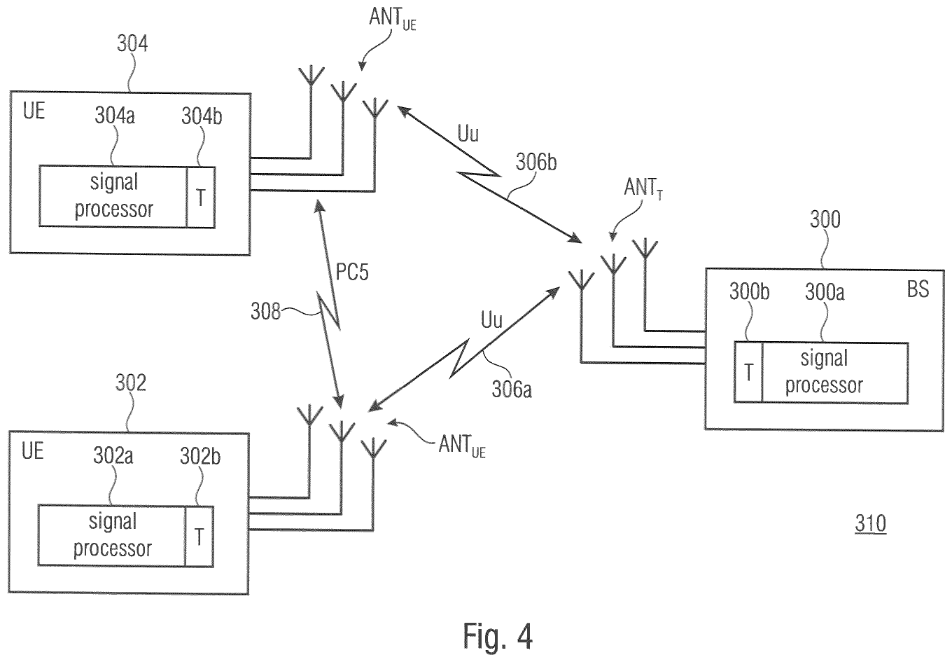

FIG. 4 is a schematic representation of a wireless communication system including a transmitter, like a base station, and one or more receivers, like user devices, UEs, for implementing embodiments of the present invention;

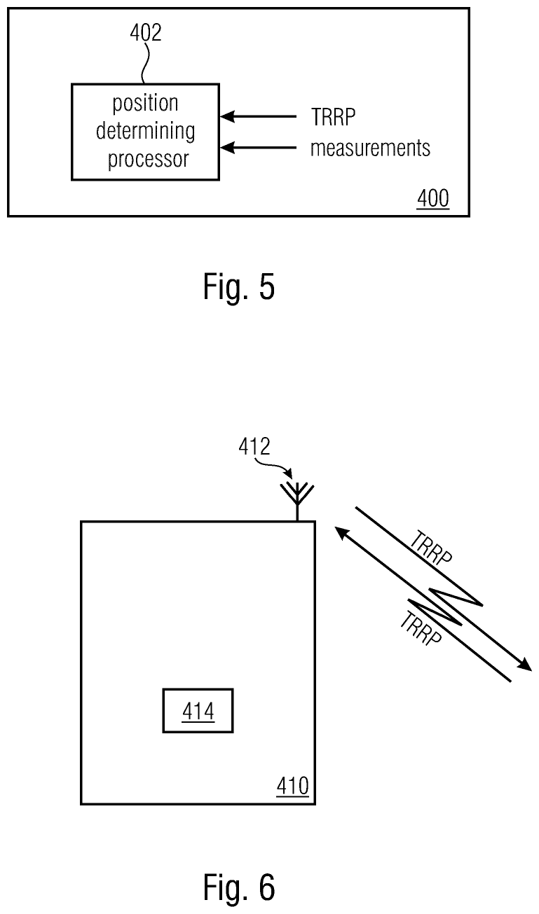

FIG. 5 describes an apparatus in accordance with an embodiment of the present invention;

FIG. 6 describes an apparatus in accordance with further embodiments of the present invention;

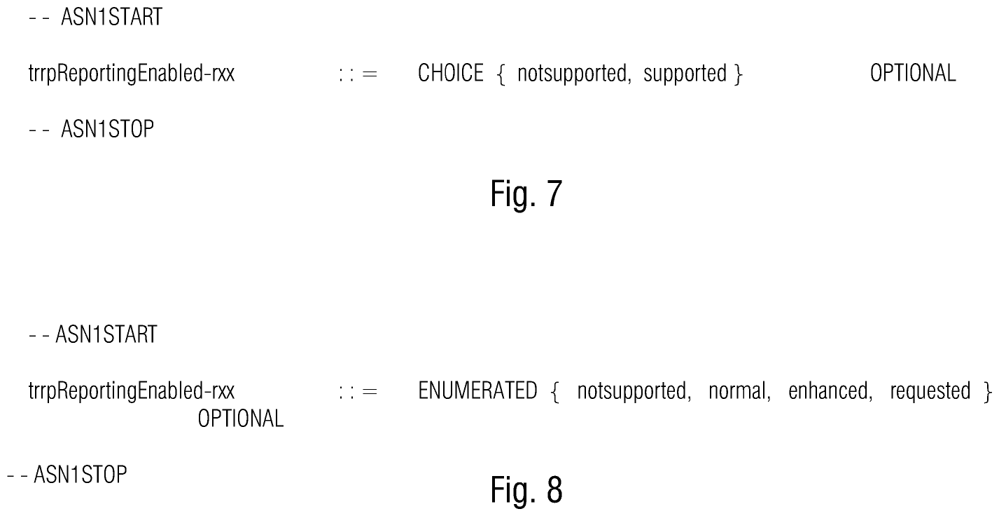

FIG. 7 illustrates an embodiment of an ASN1 snippet for signaling a TRRP calculation capability to a location server of a wireless communication network;

FIG. 8 illustrates an information element, IE, trrpReportingCapability for signaling a TRRP calculation capability in accordance with embodiments of the present invention;

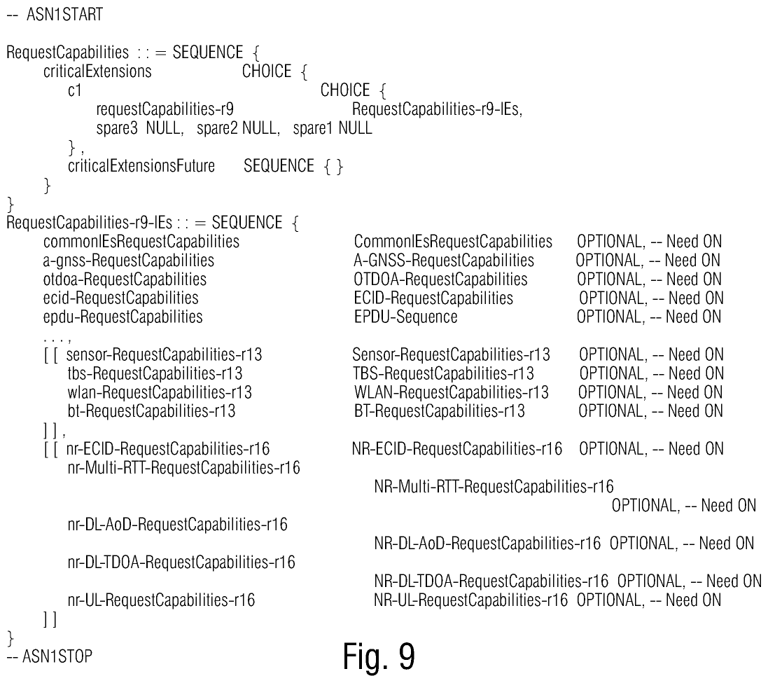

FIG. 9 illustrates an embodiment for an ASN1 syntax requesting UE capabilities by a location management function, LMF;

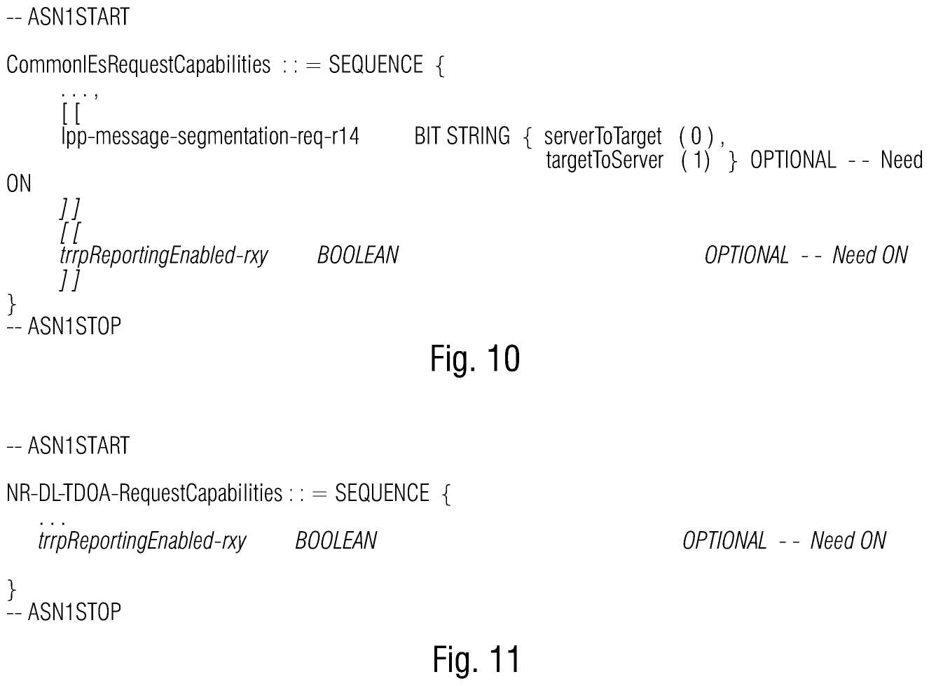

FIG. 10 illustrates an information element, IE, CommonIEsRequestCapabilities including a field trrpReportingEnabled-rxy for requesting a TRRP reporting capability in accordance with embodiments of the present invention;

FIG. 11 illustrates an embodiment for requesting capabilities for a DL-TDOA positioning method;

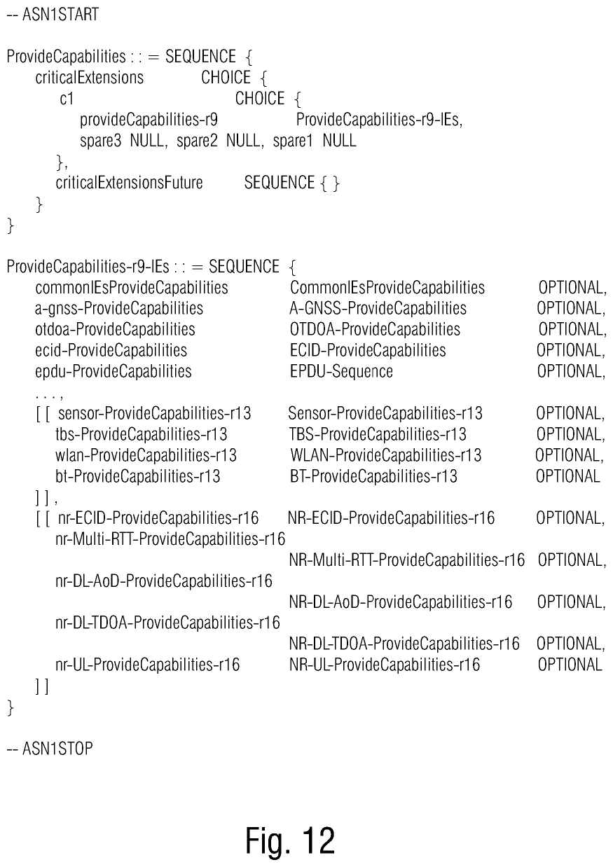

FIG. 12 illustrates an embodiment of an information element, IE, allowing a UE to signal its capability to a location server, like a LMF;

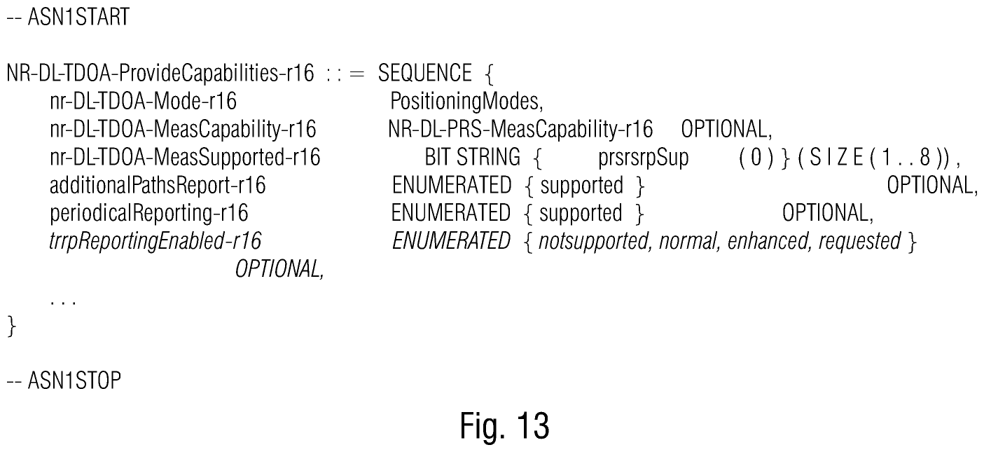

FIG. 13 illustrates an embodiment of an information element, IE, trrpReportingEnabled for a NR-DL-TDOA;

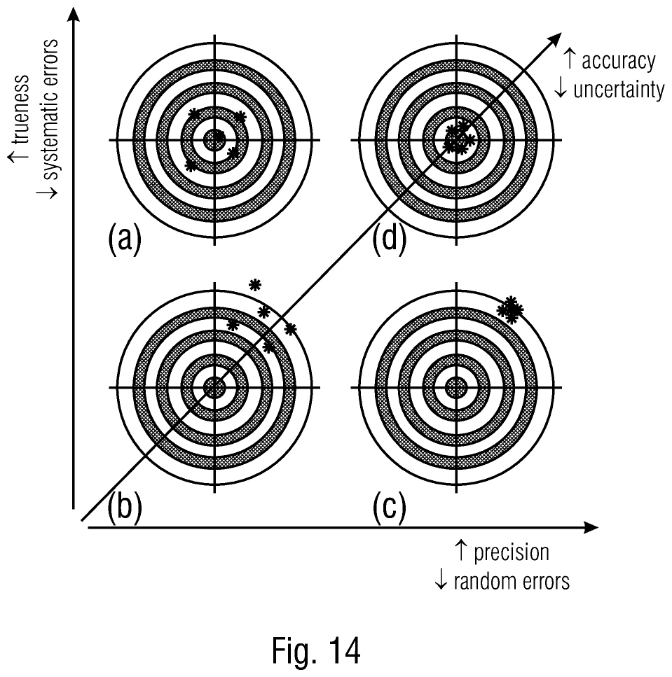

FIG. 14 illustrates concepts of accuracy, precision and trueness;

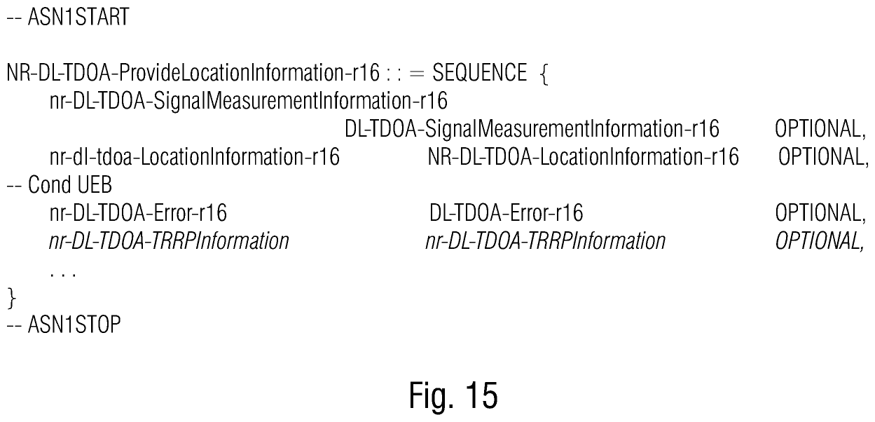

FIG. 15 illustrates an existing information element, IE, NR-DL-TDOA-ProvideLocationInformation extended by adding the TRRP information in accordance with embodiments of the present invention; and

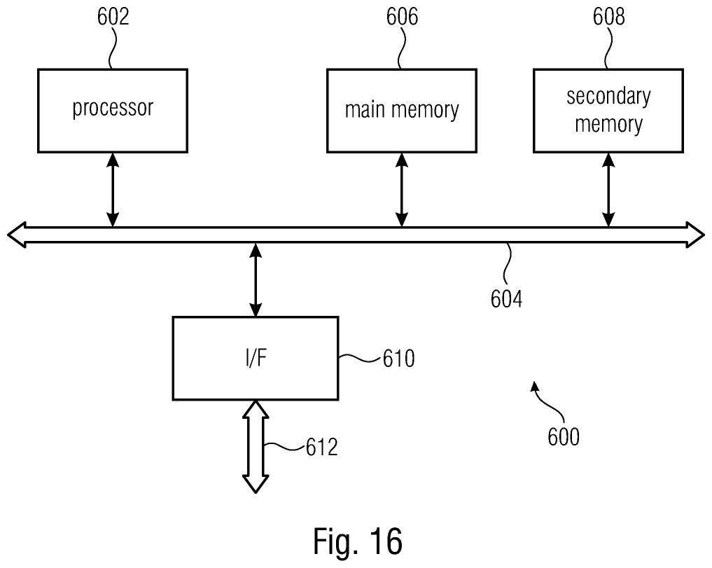

FIG. 16 illustrates an example of a computer system on which units or modules as well as the steps of the methods described in accordance with the inventive approach may execute.

Embodiments of the present invention are now described in more detail with reference to the accompanying drawings, in which the same or similar elements have the same reference signs assigned.

In a wireless communication system or network, like the one described above with reference to FIG. 1, geometry-based positioning approaches, like the OTDOA approach or the E-CID approach, may be employed for determining a position of a network entity, like a user device, using reference signals. [3GPP19-38214] describes reference signals that may be spatially filtered, and in section 5.1.6.5 “PRS reception procedure” it is stated that: “Each DL PRS resource set consists of K≥DL PRS resource(s) where each has an associated spatial transmission filter”. For the uplink it is stated in section 6.2.1.4 “UE sounding procedure for positioning purposes” that “If the UE is not configured with the higher layer parameter spatialRelationInfo the UE may use a fixed spatial domain transmission filter for transmissions of the SRS configured by the higher layer parameter [SRS-for-positioning]across multiple SRS resources or it may use a different spatial domain transmission filter across multiple SRS resources.”

For determining the position of a network entity, for example for a standalone, SA, new radio, NR, Release 16 based radio access network, RAN, a new radio positioning protocol, NRPPa, (see [3GPP19-38455]) or a long-term evolution, LTE, positioning protocol, LPP, (see [3GPP19-37355]) may be used. The purpose of the NRPPa procedure is to carry NRPPa signaling (as defined in [3GPP19-38455]) between the next generation RAN, NG-RAN, node and the location management function, LMF, over the NG interface as defined in [3GPP19-38455]. The procedure may use UE-associated signaling or non-UE associated signaling. The UE-associated signaling is used to support the E-CID, positioning of a specific UE. The non-UE associated signaling is used to obtain assistance data from an NG-RAN node to support OTDOA positioning for any UE (see [3GPP19-37355]). According to NRPPa, as described in [3GPP19-38455], the following position information may be exchanged for a position estimation at a location server:
E-CID: The NG-RAN Access Point Position is included (“The configured estimated geographical position of the antenna of the cell.”), with reference to section 9.2.10 “NG-RAN Access Point Position” where the access point position format is described.
OTDOA: The NG_RAN Access point position is included (“The configured estimated geographical position of the antenna of the cell/TP.”), with further reference to section 9.2.10“NG-RAN Access Point Position” where the access point position format is described.

FIG. 2 illustrates the network entities involved in computing the position of a UE, like UE1, and the interfaces between the other network entities. FIG. 2 illustrates a wireless communication network, like the one described with reference to FIG. 1, including the core network and the RAN implemented a cloud RAN, C-RAN. In FIG. 2 those entities are illustrated that are involved in the process for determining a location or position of the UE1. The core network 102 includes the location management function, LMF, and the Access and Mobility Management Function, AMF, which communicate using the Network Layer Signaling protocol, NLs. The C-RAN includes the distributed units gNB-DU1, gNBDU2 and gNB-DU3 connected via the F1 interface to the respective central units s-gNB and n-gNB, which, in turn, are connected via the XN interface. Further, the central units s-gNB and n-gNB are connected to the AMF of the core network 102 via the Next Generation Application Protocol, NGAP. Each of the distributed units gNB-DU1, gNBDU2 and gNB-DU3 includes a transmission reception point TRP1, TRP2 and TRP3, e.g., one or more antennas or antenna arrays. The respective distributed units gNB-DU1, gNBDU2 and gNB-DU3 may apply beamforming so that the associated transmission reception point transmits/receives using a beam directed in a specific direction, like beams 1, 2 or 3 of distributed unit gNB-DU1, beams 4, 5 or 6 of distributed unit gNBDU2 and beams 7, 8 or 9 of distributed unit gNB-DU3. In FIG. 2, during the positioning process for determining the position of UE1, the beams 1 to 9 are respective receive beams at the distributed units or base stations for receiving SRSs from the UE1, which, in turn, may apply or use different spatial domain transmission filters across multiple SRS resources so as to create one of beams A, B and C for sending the SRSs.

The spatial filters may change dynamically and may not always be confined to a limited set, e.g., by a codebook, due to the possibility of the use of UE specific spatial filters. Furthermore, 3GPP specifies 3 different categories of base stations (see e.g., TS 38.104 Rel. 16, Page 24-26):
Type 1-C: a base station with separated antennas (similar to a 4G base station and in particular common for FR1)
Type 1-H: a base station with fully integrated antenna arrays
Type 1-O, 2-O: a base station with hybrid antenna arrays, e.g., several antenna arrays may be connected to a base station, but the signal may not be measured at each antenna patch separately.

Currently Type 1-O, 2-O define a radiation reference point on the antenna array to be the reference point or timing reference point for the emitted radiation carrying an embedded positioning reference signal. For Type 1-C and Type1-H base stations the timing reference point for the positioning RS is defined at the antenna connector and the Rx Transceiver Array Boundary connector respectively. However, this leads to significant uncertainties coming from the unknown delay between the antenna port and the antenna where the origin of the radiation actually is. For example, geometry-based positioning approaches, like the OTDOA approach, conventionally use a static reference point. For example, for frequency range 1, FR1, the reference point for the downlink reference signal time difference, RSTD, is the antenna connector of the UE, and for FR2 the reference point for the downlink RSTD is the antenna of the UE (see [3GPP19-38215]). However, the measurement radio signal used for positioning, e.g. the time of flight, TOF, or the direction of arrival, DOA, relates to the transmission reception-reference-point, TRRP, and not the antenna connector position or the antenna position. For high accurate positioning or certain settings, the offset between the TRRP and the static reference point used for position calculation has a large impact on the determined position.

For a TRRP, Type1-H and Type 1-O, 2-O may be referenced which define a radiation reference point on the antenna array to be the reference point or timing reference point. For Type 1-C base stations the timing reference point for the positioning RS may be defined at the antenna connector. An advantage over type1-O is that the TRRP is dynamically determined and not a fixed which is highly relevant for an AAS system.

FIG. 3 illustrates a simplified example for an antenna array with two antennas and a spatial filter, that is denoted as the spatial receive filter P. With reference to FIG. 3 a position error is described that may originate from a phase center reference point, TRRP, shift due to changes in the beamformer, when using a static base station, BS, reference point, as is done conventionally for positioning. FIG. 3 schematically illustrates a BS with two antennas ANT1 and ANT2 and the static reference point 200 the position or location of the first antenna ANT1. Further, a true phase center 202 of the antenna array ANT1, ANT2 is shown for different spatial receive filters P. FIG. 3(a) illustrates a scenario in which the spatial receive filters P causes a receive lobe at the BS to be only formed by the first antenna ANT1. In this case, when receiving a measurement 204 from a UE the static reference point 200 and the true phase center 202 coincidence at the first antenna ANT1 so that no position error occurs, and an actual position of the UE may be accurately determined. However, when selecting the spatial receive filters P to cause a receive lobe at the BS to be formed by the first antenna ANT1 and by the second antenna ANT2 (see FIG. 3(b)) or only by the second antenna ANT2 (see FIG. 3(c)), the static reference point 200 and the true phase center 202 deviate from each other causing a position error 206 which, in turn, causes an actual position of the UE as determined to be a position within an uncertainty area 208. In FIG. 3, a TOF measurement and a DOA measurement received at the BS are combined with the static BS reference point to determine the mobile device, UE, position, like the position of a smartphone held by the user. Changing the spatial filter receive filter P, changes the true phase center or TRRP 202 and a systematic position error 206 is added to the estimated position. Similar systematic errors occur to all geometry-based positioning methods using a static reference point and a TRRP position that differs from the static reference point, either at the receiver as in FIG. 3 or at the transmitter.

Thus, in conventional approaches, time-of-flight measurements are associated with an unknown uncertainty between the timing reference point 200 and the radiation reference point, TRRP, 202. In combination with beamforming across multiple distributed antennas this uncertainty dynamically changes over time depending on an allocated precoding at a given time. In [3GPP19-22.261, 3GPP18-22.804] positioning accuracies down to below 0.2m are envisaged. With large antenna arrays and a possible large variation of the TRRP, the position error caused when using a static reference point becomes relevant, especially for accuracies in the centimeter range. Thus, a rough estimate of the reference point 200, e.g., by assuming the antenna connector instead of the applicable and real phase center 202, may no longer be sufficient for new use cases. While positioning in LTE was targeting horizontal location accuracies in the range of 50 m (up to 3GPP Release 14 and 15) to fulfil regulatory requirements (location during emergency calls), the new releases, like Release 16 addresses commercial positioning use cases aiming at horizontal accuracies down to 3 m. Release 17 increases the ambition and aims at performance targets of down to 20 cm horizontal accuracy (see [3GPP20-RP-193237]). For example, the physical dimension of antennas in frequency range 1, FR1<6 GHz, may be decimeters to meters and is given by the number of antenna elements and by the wavelength. For a common case, antenna elements are spaced at distances half of the wavelength. At 2 GHz with half a wavelength equaling 7.5 cm, the physical size of one dimension of an antenna with 8 elements in a row is 60 cm. Taking into account mechanics of the housing, the antenna connector may be even further off the phase center than these 60 cm.

The present invention addresses the above issues regarding the discrepancy in the location between the reference point and the TRRP and provides improvements and enhancements for positioning processes. Embodiments of the invention are based on the finding that the location of radiation and timing of radiation have to be related to the true or real center of radiation, referred to herein as the TRRP, for the measurements associated with position determining processes, like a measurement of the TOF or the OTDOA. In accordance with the inventive approach, to cope with the static nature of the reference point position, information about the TRRP, e.g., when the TRRP changes due to a change of a spatial filter, is provided, thereby improving the accuracy with which a geographical position may be estimated. Embodiments address the signaling and protocol aspects of a dynamically changing TRRP not treated so far in up-to-date standardization nor in literature, and how antenna reference points, i.e., phase centers of antennas used for timing and angular measurements obtained, for example, for positioning procedures, may be handled within the 3GPP standard.

In accordance with further embodiments, rather than signaling only the TRRP, also so-called Transmission and Reception Reference Information, TRRI, may be signaled, which includes, in addition to the TRRP, Transmission and Reception Delay, TRD, information, which may include information on the signal delay between the TRRP and an actual processing unit in a device processing a signal to be transmitted or received, like a baseband unit of a transmitter and/or receiver.

The inventive approach is advantageous for situations in which the accuracies needed come to be in the range of physical antenna sizes and below so that the reference points need to be correct in order not to contribute to a significant extent to a positioning error. A further advantage is that a prerequisite is provided for a precise positioning process and subsequently other network functionality, like a precisely synchronized coordinated multi-point operation in time sensitive networks. Yet another advantage is that the inventive approach handles antenna reference points adaptively in case antennas, like (massive) MIMO antennas, change their spatial setting.

Embodiments of the present invention ensure that for positioning calculations the antenna reference points/TRRPs, like timing reference points or angular reference points, are considered at least more correctly and not just as an approximate value, e.g., by assuming the antenna connector to be this point. This is an enabling prerequisite for high accuracy positioning, e.g., for supporting centimeter and decimeter accuracies. The embodiments of the inventive approach are applicable to all 3GPP positioning methods, which are either based on timing, like DL-TDOA, UL-TDOA, Multi-RTT, on angular measurements, like DL-AoD, UL-AoA, or on both, like E-CID. All these methods make use of antennas of certain physical size and in most mobile network cases use of antenna arrays, which transmit/receive beamformed signals, also referred to as precoded or spatially filtered signals. The reduction of the position error down to a few centimeters is advantageous as it allows to support commercial use cases in the industry, e.g., the guidance of AGVs, augmented reality for workers related to their physical position in respected to machinery, or traffic, like 3GPP supported autonomous driving. Thus, embodiments of the present invention may be employed for high accurate positioning, e.g.,
in factories using multi-anchor reference base stations placed in a factory, including multi-path reflections and orientation of devices to be positioned,
a positioning for V2X relative to base stations and relative to other vehicles, including an orientation of a vehicle or a predicted trajectory thereof, if applicable,
an extension to other mobile users, e.g., VRUs, like cyclists and pedestrians,
a positioning for UAVs and AVs (airborne), relative to base stations (including altitude) and relative between UAVs (relative positioning within a swarm),
a swarm of satellites following known trajectories,
a handover between different TRPs and relevant reference points may be used by a measurement unit, e.g. a UE,
a proximity detection between objects or devices and their positioning within a set of fixed reference base stations, e.g. the Corona-app feature, working also across multiple MNOs,
a base station location detection after its deployment.

Embodiments of the present invention may be implemented in a wireless communication system as depicted in FIG. 1 including base stations and users, like mobile terminals or IoT devices. FIG. 4 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink, SL, interface. When the UEs are not served by the base station or are not connected to a base station, for example, they are not in an RRC connected state, or, more generally, when no SL resource allocation configuration or assistance is provided by a base station, the UEs may communicate with each other over the sidelink, SL. The system or network of FIG. 4, the one or more UEs 302, 304 of FIG. 4, and the base station 300 of FIG. 4 may operate in accordance with the inventive teachings described herein.

Embodiments of the present invention are described in the following.

Apparatus

According to an embodiment an apparatus for determining a position of an entity of a wireless communication network, the comprising:

a position determining processor to determine a position of a first entity in the wireless communication network using one or more position measurements between the first entity and one or more second entities, each of the first and second entities comprising one or more antennas to transmit and/or receive a radio signal for the position measurement,

wherein the position determining processor is to determine the position of the first entity using a transmission reception reference point, TRRP, of the radio signal at the one or more antennas of the first entity and/or the one or more second entities.

According to an embodiment, the apparatus is provided in one or more of
a core entity, like a Location Management Function, of a core of the wireless communication network, and is to receive the TRRPs for the first entity and the one or more second entities,
the first entity, e.g., a radio access network, RAN, entity or a user device of the wireless communication network, the first entity to receive the TRRPs for the one or more second entities,
the one or more second entities, e.g., a radio access network, RAN, entity, or a user device of the wireless communication network, the second entity to receive the TRRP for the first entity.

According to an embodiment, an apparatus for a wireless communication network, comprises:

one or more antennas, the one or more antennas to transmit a radio signal,

wherein the apparatus is to transmit a transmission or reception position, TRRP, of the radio signal at the one or more antennas to be used for a position determining process.

According to an embodiment, an apparatus for a wireless communication network, comprises

one or more antennas, the one or more antennas to receive a radio signal from one or more radio access network, RAN, entities and/or user devices of the wireless communication network,

wherein the apparatus is to receive a transmission or reception position, TRRP, of the radio signal transmitted by one or more antennas of the respective RAN entities and/or user devices, and

wherein the one or more received TRRPs are to be used for a position determining process implemented in the apparatus or in a network entity remote from the apparatus, the determining process determining the position of the apparatus using the received TRRPs.

According to an embodiment, the one or more antennas comprise one or more of
a plurality of separate antennas,
one or more antenna arrays, like a fully integrated antenna array, each antenna array comprising a plurality of antenna elements.

According to an embodiment, the TRRP of the one or more antennas is the location or point from which electromagnetic waves of the radio signal seem to be originating, like a phase center or a radiation reference point of the one or more antennas.

According to an embodiment, the TRRP changes dependent on one or more of the following parameters:
a carrier frequency of the radio signal,
when using a spatial filter, like a precoder or beamformer, a direction of the beam and/or a power scaling over the antennas,
an antenna mode in case of multi-mode antennas,
a total output transmit power due to impedance changes.

According to an embodiment, the TRRP is indicated as
an absolute position, e.g., indicated by coordinates in the Cartesian format, the spherical format, or of the World Geodetic System 1984, WGS 84, and/or
a position relative to a predefined reference point, like an antenna connector or an antenna position.
According to an embodiment, the TRRP is associated with certain signals or spatial filters, e.g. in case of a codebook-based transmission, the TRRP is associated with one or more codewords from the codebook.

According to an embodiment, the apparatus is to signal a capability of the apparatus to compute the TRRP for the one or more antennas of the apparatus.

According to an embodiment, the apparatus is to signal the capability to compute the TRRP responsive to
a certain event, like the apparatus accessing the wireless communication network, or a deviation of a new TRRP from a current TRRP by a configured or preconfigured amount, and/or
a request, like a positioning measurement request.

According to an embodiment,
the apparatus is a user device, like a UE, and is to signal the capability to compute the TRRP to a core entity, like a Location Management Function, of a core of the wireless communication network using the long-term evolution, LTE, positioning protocol, LPP, or
the apparatus is a RAN entity, like a gNB, and is to signal the capability to compute the TRRP to a core entity, like a Location Management Function, of a core of the wireless communication network using the new radio positioning protocol, NRPPa, or
the apparatus is a cloud-RAN, C-RAN, entity, like a gNB-CU or a gNB-DU, and is to signal the capability to compute the TRRP to
   another C-RAN entity, like a gNB-CU or a gNB-DU, using the frequency 1 application protocol, F1 AP, interface, and
   a core entity, like a Location Management Function, of a core of the wireless communication network using the new radio positioning protocol, NRPPa.

According to an embodiment, the apparatus is to signal the TRRP with respect to a set of specific or fixed operating conditions, e.g., one or more of a fixed operating frequency, like a center frequency of a given NR operating band, a fixed beam direction, like a boresight direction or a direction in which all beamforming weights are reset so as not to electronically scan the beam away from boresight, and a fixed polarization, like a single polarization such as vertical, horizontal, left-hand circular or right-hand circular.

According to an embodiment, the apparatus is to signal the TRRP with respect to the apparatus' current operating conditions, e.g., one or more of a current frequency of operation, a current beam direction, a current polarization.

According to an embodiment, the apparatus is to signal the TRRP as an absolute position or as position relative to a TRRP obtained by a predefined or reference set of operating conditions.

According to an embodiment, the apparatus, responsive to a request, is to signal the TRRP
with respect to a set of specific or fixed operating conditions, or
with respect to the apparatus' current operating conditions which may include one or more of:
the current frequency of operation;
the current beam direction;
the current polarization.

According to an embodiment, the TRRP is signaled
explicitly or implicitly in a control message, like a DCI, of a RAN entity, or
in an over the top, OTT, channel connected to a database, e.g. in the internet, holding the TRRP.

According to an embodiment, the TRRP is stored at one or more of:
a database associated with the core entity, like the Location Management Function, LMF, and/or the Access and Mobility Function, AMF,
one or more stationary or moving RAN entities, like a gNB, a reference TRP, a relay node,
one or more user devices, like a UE.

TRD Information

According to an embodiment, the position determining processor is to determine the position of the first entity further using transmission and reception delay, TRD, information.

According to an embodiment, the TRRP and the TRD information are provided as Transmission and Reception Reference Information, TRRI.

According to an embodiment, the TRD information includes information on the signal delay between the TRRP and a baseband unit of a transceiver unit, and/or delay information about one more of the following: a transceiver unit, TXRU, delay, a transceiver array boundary, a radio distributed network, a physical antenna array, information on the way the TRD information were determined, e.g., one or more of:
Tx/Rx TRRP
Tx/Rx antenna connector
Tx/Rx antenna
Tx/Rx Transceiver Array Boundary connector.

According to an embodiment,

the TRD information comprises a loopback delay measured from a first transmit TRRP to a second receive TRRP of the apparatus, each TRRP being associated with a different antenna of the apparatus, and

a measurement of the loopback delay is limited to TRRPs being outside a certain range R, like the near field range.

According to an embodiment,

$$R > X \frac{{D}^{2}}{λ}$$

or

$$R > X \sqrt{\frac{{D}^{3}}{λ}}$$

with
λ wavelength of the transmitted or received signal,
D the distance separating the first and second TRRPs,
X a scaling factor in the range between 0.01 and 3; wherein X is a scaling factor, e.g., for near the radiating near field value of X to be 2 between two devices but can be changed or relaxed for TRD determination for the same device.

According to an embodiment, when performing the loopback delay measurement from the first transmit TRRP to the second receive TRRP, the apparatus is not expected to use a Tx-RX spatial filter pair for determining the loopback delay within the range of R.

According to an embodiment,

the TRD delay information reports delays associated to spatial filters used for a transmission and/or reception of UL or DL positioning reference signals used for a certain positioning method, like a SRS, a PRS, a CSI-RS, a SSB, a sidelink PRS or any other reference signal employed for positioning, and

the reported delays are selected based on the one or more Tx spatial filters used to transmit one or more of the positioning reference signals and/or on the one or more Rx spatial filters used to perform a measurement on the positioning reference signals, like a RTOA, RSTD, UE Rx-Tx, gNB Rx-Tx or any timing related measurement.

According to an embodiment,

in case of a DL and UL based positioning method, like Multi-RTT or eCID, a UE is configured with an UL-PRS configuration to determine the Tx-Rx delay and with a measurement gap to perform TRD measurements for the configured UL-PRS signal, and a TRP is configured with a DL-PRS configuration to determine the Tx-Rx delay, in case of a DL based positioning method, like DL-TDOA, a UE is configured with an UL-PRS configuration to determine the Rx delay and a measurement gap to perform TRD measurements for the configured UL-PRS signal,

in case of an UL based positioning method, like UL-TDOA, a TRP is configured with a DL-PRS configuration to determine the Rx delay.

According to an embodiment, the TRD is indicated explicitly, e.g., by signaling the actual TRD associated with a certain reference signal, RS, or measurement, or implicitly, e.g., by signaling a TRD indication.

According to an embodiment, in case of an implicit TRD, the TRD is indicated using one or more TRD identifiers, each TRD identifier representing the TRD associated with a certain reference signal, RS, and/or a certain measurement.

According to an embodiment, the TRDs of two or more RSs or measurements having the same TRD or having TRDs that are within a predefined range of TRDs, the TRD is indicated using the same TRD identifier.

According to an embodiment, the apparatus comprises a UE, in case of employing a DL positioning method, each TRD identifier indicates the TRD used for the reception or measurement of one or more of DL positioning reference signals, and in case of employing an UL positioning method, each TRD identifier indicates the TRD used for the transmission or measurement of one or more of UL positioning reference signals.

According to an embodiment, the apparatus comprises a TRP, in case of employing a DL positioning method, each TRD identifier indicates the TRD used for the transmission or measurement of one or more of DL positioning reference signals, and in case of employing an UL positioning method, each TRD identifier indicates the TRD used for the reception or measurement of one or more of UL positioning reference signals.

According to an embodiment, the apparatus comprises a UE or a TRP, in case of employing both a DL positioning method and an UL positioning method, each TRD identifier indicates the TRD used for the reception of one or more of DL positioning reference signals and the transmission of one or more UL positioning reference signals.

According to an embodiment, the apparatus is to receive the one or more TRD identifiers from a LMF.

According to an embodiment, in case of employing a positioning method including measurements at a first location and at a second location, the indication includes for an UL or DL and DL or UL measurement
one TRD identifier for the UL transmission and one TRD identifier for the DL reception, or
one TRD identifier for the DL transmission and one TRD identifier for the UL reception.

According to an embodiment, the apparatus is to receive instructions, e.g., from a higher-layer-interface, to provide information on the TRD information.

According to an embodiment, in case the TRD information is provided by a network entity, like a UE, capable to simultaneously transmit or/and receive on different frequency parts, the TRD information indicates if the TRDs for the UL positioning reference signals and/or for the DL measurements of the DL positioning reference signals on the first frequency part and second frequency part are the same or are within a predefined range of TRDs.

According to an embodiment, the TRD information includes the band indices of the different frequency parts.

According to an embodiment, the apparatus comprises a UE capable to simultaneously receive one or more positioning reference signals on a first frequency part and on a second frequency part; and

the UE is to receive from the network information on the one or more TRDs at the TRP for the DL positioning reference signals on the first frequency part and on the second frequency part, wherein the UE may apply received one or more TRDs to process a time of arrival or a direction arrival estimation of the DL positioning reference signals received from the first and second frequency parts.

According to an embodiment, the first entity, like a UE, is to transmit one or more reference signals at different time instants using a plurality of different transmission, TX, filters, and is to provide to the apparatus the TRD information for each TX filter used, each TRD information being associated with a timestamp,

the apparatus is to receive form the one or more second entities, like a TRP, one or more measurement reports including measurements of the one or more reference signals transmitted by the first entity, the one or more measurement reports including time information about the time instants of the measurements of the reference signals, and

the apparatus is to map the TRD information received from the first entity to the one or more measurement reports received from the second entity using the timestamps associated with the TRD information and the time information.

According to an embodiment, the first entity, like a UE, is to receive one or more reference signals at different time instants using a plurality of different reception, RX, filters, and is to provide to the apparatus the TRD information for each RX filter used, each TRD information being associated with a timestamp, the apparatus is to receive form the first entity, one or more measurement reports including measurements of the one or more reference signals received by the first entity, the one or more measurement reports including time information about the time instants of the measurements of the reference signals, and the apparatus is to map the TRD information received from the first entity to the one or more measurement reports received from the second entity using the timestamps associated with the TRD information and the time information.

General According to an embodiment, the position determining processor operates in accordance with one or more of the following positioning methods:
angle of arrival, AoA,
angle of departure, AoD,
time of arrival, ToA,
time of flight, ToF,
time difference of arrival, TDOA, like OTDOA and UL-TDOA
enhanced Cell ID,
NR-Multi-RTT.

According to an embodiment,

the user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity, and

the RAN entity base station comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

System

According to an embodiment, a wireless communication system, comprises one or more apparatus of any one of the preceding claims.

Method

According to an embodiment, a method for operating an apparatus for determining a position of an entity of a wireless communication network comprises:

determining a position of a first entity in the wireless communication network using one or more position measurements between the first entity and one or more second entities, each of the first and second entities comprising one or more antennas to transmit and/or receive a radio signal for the position measurement, and

determining the position of the first entity using a transmission reception reference point, TRRP, of the radio signal at the one or more antennas of the first entity and/or the one or more second entities.

According to an embodiment, a method for operating an apparatus for a wireless communication network, comprises

using one or more antennas, the one or more antennas to transmit a radio signal,

such that a transmitted transmission or reception position, TRRP, of the radio signal at the one or more antennas is used for a position determining process.

According to an embodiment, a method for operating an apparatus for a wireless communication network, the apparatus comprising one or more antennas, the one or more antennas to receive a radio signal from one or more radio access network, RAN, entities and/or user devices of the wireless communication network, comprises

receiving a transmission or reception position, TRRP, of the radio signal transmitted by one or more antennas of the respective RAN entities and/or user devices, and

using the one or more received TRRPs for a position determining process implemented in the apparatus or in a network entity remote from the apparatus, the determining process determining the position of the apparatus using the received TRRPs.

Computer Program Product

Embodiments of the present invention provide a computer program product comprising instructions which, when the program is executed by a computer, causes the computer to carry out one or more methods in accordance with the present invention.

As described above, a geometry based object positioning or localization is based on wireless measured radio signals, usually distance measures, like the time of flight, TOF, or direction measures, like an angle of arrival, AOA, or an angle of departure, AOD, in combination with the position of the origin or position of the transmitted or received radio signal. This transmission or reception position of the radio signal is called herein the transmission-or-reception-reference-point, TRRP. As explained above, the TRRP may be non-static and may change depending on various parameters, such as
the carrier frequency of the signal,
the used spatial filter (precoder or beamformer) on an antenna array,
   by the direction of the beam, and
   by power scaling over antennas,
the antenna mode in case of multi-mode antennas,
the total output transmit power due to impedance changes.

To address the drawbacks found in prior art approaches, embodiments of the present invention describe
how the TRRP information is exchanged and updated in a mobile communications system, e.g., a cellular NR 5G network,
how the TRRP relates to already existing measurements exchanged for positioning, and
procedures required for the exchange of the TRRP information.

FIG. 5 describes an apparatus 400 in accordance with an embodiment of the present invention. The apparatus 400 determines a position of an entity, like a UE or a gNB, of a wireless communication network, like the one described above, using the TRRP of the antennas, which are used for transmitting and receiving distance or direction measurement signals. The apparatus 400 includes a position determining processor 402 for determining a position of a first entity in the wireless communication network using one or more position measurements between the first entity and one or more second entities. Each of the first and second entities comprising one or more antennas to transmit and/or receive a radio signal for the position measurement. The position determining processor determines the position of the first entity using a transmission-or-reception-reference-point, TRRP, of the radio signal at the one or more antennas of the first entity and/or the one or more second entities. In accordance with embodiments, the apparatus 400 may be part of the core network, part of a UE or part of a gNB. For example, the apparatus 400 may be implemented in
a core entity, like a Location Management Function, LMF, of a core of the wireless communication network, that receives the TRRPs for the first entity and for the one or more second entities, or
the first entity, e.g., a radio access network, RAN, entity or a user device of the wireless communication network, that receives the TRRPs for the one or more second entities, or
the one or more second entities, e.g., a radio access network, RAN, entity, or a user device of the wireless communication network, that receives the TRRP for the first entity.

FIG. 6 describes an apparatus 410 in accordance with further embodiments of the present invention. The apparatus 410 may be a user device, UE, or a RAN entity, like a gNB, and includes one or more antennas 412 for transmitting a radio signal. The apparatus 410 transmits a transmission-or-reception-reference-point, TRRP, of the radio signal at the one or more antennas 412 to be used for a position determining process.

In accordance with embodiments, the one or more antennas 412 receive a radio signal from one or more radio access network, RAN, entities and/or user devices of the wireless communication network. The apparatus 410 receives a transmission-or-reception-reference-point, TRRP, of the radio signal transmitted by one or more antennas of the respective RAN entities and/or user devices. The one or more received TRRPs, in accordance with a first embodiment, may be used for a position determining process 414 implemented in the apparatus 410. In accordance with a second embodiment, the apparatus 410 may provide the received TRRPs to a network entity remote from the apparatus 410 that performs a position determining process. The determining process determines the position of the apparatus 410 using the received TRRPs.

The above-mentioned radio signal may be obtained by beamforming or spatial filtering, which is a signal processing technique used in antenna arrays for directional signal transmission or reception. This is achieved by combining elements in an antenna array in such a way that signals at particular angles experience constructive interference while others experience destructive interference. Beamforming may be used both at the transmitting end and at the receiving end in order to achieve spatial selectivity. The improvement compared with omnidirectional reception/transmission is known as the directivity of the array (see [Wik20]). For systems that operate above 6 GHz, the so-called millimeter-wave range, beamforming is essential as the highly directional transmission compensates for the significant propagation and penetration losses. Digital beamforming provides greatest flexibility as it enables the connection of each antenna element to its own RF chain. At mmWave frequencies, however, and when a large number of antenna elements are used, digital beamforming may become prohibitive in terms of complexity, power consumption and cost in general (see [RHJDM15]). Analogue beamforming, on the other hand, is normally implemented using phase shifters and electrical delays. It has limited flexibility in dynamically controlling the radiation pattern, especially when multibeam patterns are considered, but is an attractive option mostly due its relative simplicity and the fewer number of RF chains required. For these reasons, mmWave systems may have a hybrid configuration, in which beamforming is performed in both the digital and analogue domains. In hybrid beamforming, an analogue beamformer typically includes of a number of sub-arrays, in which each sub-array has a dedicated RF chain (see [RHJDM15]).

The input impedance of an antenna array, like Zₘ of the m^{th} element in a linear array, or Z_{m,n}, in a rectangular array, which is mutually coupled to all other elements, is also referred to as the active impedance (see [Vis06] stating: “the active impedance is defined as that impedance seen by a generator connected to one array element when all other array elements are active [Bal67]”). Since current is the origin of electromagnetic radiation, the mutual coupling will not only affect the input impedances of the elements in the array, but also their radiation patterns. The mutual coupling effects, in general, change with element position, angle of radiation and frequency and depend on the type of array element under consideration (see [Vis06]). Thus, the mutual coupling affects the phase center of an antenna. Further, in a hybrid or analogue beamformer comprised of time delay elements or phase shifters implemented in the form of electronic circuits including both discrete and integrated elements, the scattering or S parameters of such circuits varies as a function of the following operational parameters: frequency; power level; required delay or phase setting; and the impedance seen looking out of the input and output ports of the circuit, device or component (see [Qur19]). In other words, the time delay or phase shifter also has, in effect, its own form of active impedance which is affected by one or more of the aforementioned operating conditions. As such, these active impedance effects of the beamforming network interact with the active impedance of the antenna and thus further affect the phase center of an antenna.

Thus, the TRRP of an antenna in an apparatus as described above with reference to FIG. 6 may change dependent on the way the actual radio signal is generated by the antenna of the apparatus. In accordance with embodiments, the TRRP, also referred to or known as phase center or radiation reference point, may be determined or computed by the respective entities sending or receiving the radio signal using well known approaches, e.g., for a single element antenna in a way as described in [GFWWE11], for linear phased arrays in a way as described in [NR17] or for multi-mode antennas in a way as described in [AH20]. In [HGC16] a method to calculate phase center locations for arbitrary antenna systems and scenarios is presented. In [Zeil1, CGS+04] the phase center is calculated for GNNS systems to improve position accuracy. In [FBCF19] the phase center is computed for image processing in the medial area. However, it is to be noted that none of the references describes that such information about the TRRP is exchanged within the network for position calculation. The inventive approach provides embodiments for covering the correspondence of TRRP information to other measurements for geometry-based positioning by signaling the TRRP from the transmitter and/or receiver to a location where the position calculation takes place, like the LMF in NR.

TRRP Capability Signaling

In accordance with embodiments, the apparatus 410 may be a UE or a base station, BS, and the UE/BS capability to calculate or compute the TRRP may be signaled, e.g., while the UE is accessing the network or in case a positioning measurement request is send. This signaling, in the simplest form, may be a one-bit field that indicates whether an entity, e.g., a UE or a BS, capable of determining and/or signaling the TRRP or not. FIG. 7 illustrates an embodiment of an ASN1 snippet for signaling the TRRP calculation capability to a location server of a wireless communication network using, e.g., the information element, IE, trrpReportingCapability indicating whether TRRP calculation and reporting is supported or not. In accordance with other embodiments, the TRRP calculation capability regarding the possible accuracy supported by an entity may be signaled to the location server using an information element, IE, trrpReportingCapability indicating whether TRRP calculation and reporting is not supported or is supported in form of a normal reporting, enhanced reporting or requested reporting as illustrated in FIG. 8 and as described in more detail below.

The signaling mechanism by which the TRRP calculation capability is transferred to the LMF may depend on whether the TRRP of the UE or the TRRP of a base station or another TRP is to be signaled to the LMF. In accordance with embodiments, for signaling the TRRP calculation capability of a UE to the location server, the LPP protocol may be used. The LPP provides two methods—Request Capabilities and Provide Capabilities—to request and transfer capabilities between the UE and the location server. The method Request Capabilities allows the LMF to ask the UE to provide its capabilities and the method Provide Capabilities allows the UE to send its capabilities to the LMF, either in response to the Request Capabilities message or proactively by a UE.

FIG. 9 illustrates an embodiment, where the TRRP calculation capability signaling may be included together with other capabilities reports or in a position related report. In LPP, the method ‘Provide Capabilities’ transfers the UE capability to the LMF, i.e., to the location server. This may either be unsolicited or in response to ‘Request Capability’ sent to the UE from the LMF. FIG. 9 illustrates an ASN1 syntax requesting the UE capabilities by the LMF.

In accordance with embodiments, also a TRRP reporting capability may be requested using the IE CommonIEsRequestCapabilities illustrated in FIG. 10 using the field trrpReportingEnabled-rxy. The presence of the field trrpReportingEnabled-rxx, where xx in rxx denotes the 3GPP release where this capability is introduced, signals to the UE to report whether or not it supports TRR reporting.

In accordance with other embodiments, the LMF may request the UE to signal its capabilities by including the request in the information element corresponding to a positioning method where the location server wishes to know whether the TRRP reporting is enabled or not. FIG. 11 illustrates an embodiment for requesting such capabilities for a DL-TDOA positioning method. The signaling request for other positioning methods, like NR-Multi-RTT, AoD, UL-TDOA may be done in a similar manner.

The UE may signal the LMF whether or not it supports TRRP signaling either by responding to the request capabilities method, as described above, or the UE may announce its capabilities by making an unsolicited capability transfer. FIG. 12 illustrates an embodiment of an IE allowing a UE to signal its capability to the location server.

For each method included within the ProvideCapabilities method, the IE trrpReportingEnabled may be included, for example for the NR-DL-TDOA as illustrated in FIG. 13.

On the network side, the LMF may inquire the configuration at the TRPs using the NRPPa protocol. Class 1 elementary procedures may be used to request information pertaining to the TRPs. The elementary procedure [Positioning Method] Information Exchange, which consists of [POSITIONING METHOD] INFORMATION REQUEST followed by [POSITIONING METHOD] INFORMATION RESPONSE or [POSITIONING METHOD]INFORMATION FAILURE is used for exchanging the necessary information. For example, the methods for OTDOA are named OTDOA INFORMATION REQUEST and OTDOA INFORMATION RESPONSE, respectively.

The requestor information is transferred from the LMF to a NG-RAN node by including the IE OTDOA Information Item within the OTDOA Information Request. A request in accordance with the current version of specification may look like:

| | | | | | | |
|---|---|---|---|---|---|---|
| | | | IE type | Semantics | | Assigned |
| IE/Group Name | Presence | Range | and reference | description | Criticality | Criticality |

| | | | | | |
|---|---|---|---|---|---|
| Message Type | M | | 9.2.3 | YES | reject |
| NRPPa Transaction | M | | 9.2.4 | — | — |
| ID | | | | | |
| OTDOA Information | | 1 . . . | | EACH | reject |
| Type | | <maxnoOTDOAtypes> | | | |
| >OTDOA | M | | ENUMERATED (pci, cellid, | — | — |
| Information Item | | | tac, earfcn, prsBandwidth, | | |
| | | | prsConfigIndex, cpLength, | | |
| | | | noDlFrames, | | |
| | | | noAntennaPorts, | | |
| | | | SFNInitTime, nG- | | |
| | | | RANAccessPointPosition, | | |
| | | | prsmutingconfiguration, | | |
| | | | prsid, tpid, tpType, | | |
| | | | crsCPlength, dlBandwidth, | | |
| | | | multipleprsConfigurationsperCell, | | |
| | | | prsOccasionGroup, | | |
| | | | prsFrequencyHoppingConfiguration, . . . , | | |
| | | | tddConfig) | | |

In accordance with the inventive approach, the capability of the TRP may be requested by adding a field trrpReporting within the field OTDOA Information Item, and a modified IE may look like:

| | | | | |
|---|---|---|---|---|
| >OTDOA | M | ENUMERATED (pci, cellid, | — | — |
| Information | | tac, earfcn, prsBandwidth, | | |
| Item | | prsConfigIndex, cpLength, | | |
| | | noDlFrames, | | |
| | | noAntennaPorts, | | |
| | | sFNInitTime, nG- | | |
| | | RANAccessPointPosition, | | |
| | | prsmutingconfiguration, | | |
| | | prsid, tpid, tpType, | | |
| | | crsCPlength, dlBandwidth, | | |
| | | multipleprsConfigurationsperCell, | | |
| | | prsOccasionGroup, | | |
| | | prsFrequencyHoppingConfiguration, . . . , | | |
| | | tddConfig | | |
| | | trrpReportingEnabled) | | |

The Capability query may be extended on the Information Request for other methods, by adding the trrpReportingEnabled field on the query.

With further reference to the OTDOA embodiment above, the information regarding the TRRP may be included within the OTDOA Cell Information of the OTDOA Information Response Message. The currently specified message is as follows:

| | | | IL type | Semantics | | Assigned |
|---|---|---|---|---|---|---|
| IE/Group Name | Presence | Range | and reference | description | Criticality | Criticality |
| Message Type | M | | 9.2.3 | | YES | reject |
| NRPPa Transaction | M | | 9.2.4 | | — | |
| ID | | | | | | |
| OTDOA Cells | | 1 . . . | | Served | GLOBAL | ignore |
| | | <maxCellinRANnode> | | cells/TPs | | |
| | | | | that | | |
| | | | | broadcast | | |
| | | | | PRS. May | | |
| | | | | be used to | | |
| | | | | signal | | |
| | | | | multiple PRS | | |
| | | | | configurations | | |
| | | | | per cell/ | | |
| | | | | TPs (up | | |
| | | | | to 3 are | | |
| | | | | supported in | | |
| | | | | this release). | | |
| >OTDOA Cell | M | | 9.2.15 | | — | — |
| Information | | | | | | |
| Criticality Diagnostics | O | | 9.2.2 | | YES | ignore |

| | | | | Semantics |
|---|---|---|---|---|
| IE/Group Name | Presence | Range | IE type and reference | description |
| OTDOA Cell Information | | 1 . . . | | |
| | | <maxnoOTDOAtypes> | | |
| >CHOICE OTDOA Cell | M | | | |
| Information Item | | | | |
| >>PCI EUTRA | M | | INTEGER (0 . . . 503, . . .) | Physical Cell ID of the |
| | | | | reported E-UTRA cell. |
| >>CGI EUTRA | M | | 9.2.7 | Cell Global Identifier of |
| | | | | the E-UTRA cell. |
| >>TAC | M | | 9.2.11 | Tracking Area Code |
| >>EARFCN | M | | INTEGER (0 . . . 262143, . . .) | Corresponds to N_{DL} for |
| | | | | FDD and N_{DL/UL} for |
| | | | | TDD in ref. TS 36.104 |
| | | | | [7]. |
| >>PRS Bandwidth EUTRA | M | | ENUMERATED (bw6, | Transmission |
| | | | bw15, bw25, bw50, | bandwidth of PRS |
| | | | bw75, bw100, . . .) | |
| >>PRS Configuration | M | | INTEGER (0 . . . 4095, . . .) | PRS Configuration |
| Index EUTRA | | | | Index, ref TS 36.211 |
| | | | | [10] |
| >>CP Length EUTRA | M | | ENUMERATED (Normal, | Cyclic prefix length of |
| | | | Extended, . . .) | the PRS |
| >>Number of DL Frames | M | | ENUMERATED (sf1, sf2, | Number of consecutive |
| EUTRA | | | sf4, sf6, . . .) | downlink subframes |
| | | | | N_{PRS} With PRS, ref TS |
| | | | | 36.211 [10] |
| >>Number of Antenna | M | | ENUMERATED(n1-or- | Number of used |
| Ports EUTRA | | | n2, n4, . . .) | antenna ports, where |
| | | | | n1-or-n2 corresponds |
| | | | | to 1 or 2 ports, n4 |
| | | | | corresponds to 4 ports |
| >>SFN Initialisation Time | M | | BIT STRING (64) | Time in seconds |
| EUTRA | | | | relative to 00:00:00 on |
| | | | | 1, Jan. 1900 |
| | | | | (calculated |
| | | | | continuous time |
| | | | | without leap seconds |
| | | | | and traceable to a |
| | | | | common time |
| | | | | reference) where |
| | | | | binary encoding of the |
| | | | | integer part is in the |
| | | | | first 32 bits and binary |
| | | | | encoding of the |
| | | | | fraction part in the last |
| | | | | 32 bits. The fraction |
| | | | | part is expressed with |
| | | | | a granularity of 1/ |
| | | | | 2**32 second. |
| >>NG-RAN Access Point | M | | 9.2.10 | The configured |
| Position | | | | estimated |
| | | | | geographical position |
| | | | | of the antenna of the |
| | | | | cell/TP. |
| >>PRS Muting | M | | 9.2.16 | The configuration of |
| Configuration EUTRA | | | | positioning reference |
| | | | | signals muting pattern. |
| >>PRS-ID EUTRA | M | | INTEGER (0 . . . 4095, . . .) | PRS ID, ref TS 36.211 |
| | | | | [10]. |
| >>TP-ID EUTRA | M | | INTEGER (0 . . . 4095, . . .) | Identity of the |
| | | | | transmission point. |
| | | | | This IE together with |
| | | | | the PCI and/or PRS-ID |
| | | | | may be used to identify |
| | | | | the transmission point |
| | | | | in case the same |
| | | | | physical cell ID is |
| | | | | shared by multiple |
| | | | | transmission points. |
| >>TP Type EUTRA | | | ENUMERATED (prs- | A TP which transmits |
| | | | only-tp, . . .) | PRS only. |
| >>Number of DL Frames- | M | | INTEGER (1 . . . 160, . . .) | Number of consecutive |
| Extended EUTRA | | | | downlink subframes |
| | | | | N_{PRS} With PRS, ref TS |
| | | | | 36.211 [10]. |
| >>CRS CP Length EUTRA | | | ENUMERATED (Normal, | Cyclic prefix length of |
| | | | Extended, . . .) | the CRS. |
| >>DL Bandwidth EUTRA | M | | ENUMERATED (bw6, | DL transmission |
| | | | bw15, bw25, bw50, | bandwidth expressed |
| | | | bw75, bw100, . . .) | in units of resource |
| | | | | blocks N_{RB}, ref TS |
| | | | | 36.104 [7]. |
| >>PRS Occasion Group | M | | ENUMERATED (og2 | PRS occasion group in |
| EUTRA | | | og4, og8, og16, og32; | a PRS period, ref TS |
| | | | og64, og128, . . .) | 36.211 [10]. |
| >>PRS Frequency | M | | 9.2.17 | PRS frequency |
| Hopping Configuration | | | | hopping configuration. |
| EUTRA | | | | |
| >>TDD Configuration | M | | 9.2.18 | TDD specific physical |
| EUTRA | | | | channel configuration. |

The field NG-RAN Access Point Position provides a means for a NG-RAN node to provide the location of a TRP to the LMF. A field new TRRPPositionList may be added within this message to signal the TRRPs for various beamforming configurations, e.g., up to maxBeamsPerTRP configurations. The TRRPPosition may have the same format as the NG-RAN Access Point Position.

| | | | | |
|---|---|---|---|---|
| >>TRRPPositionList | | 1 . . . <maxBeamsperTRP> | | |
| >>>TRRPPosition | O | | Ellipsoid point with altitude | The configured estimated |
| | | | and uncertainty ellipsoid | geographical position of the |
| | | | according to TS 23.032 | antenna of the phase center |

In accordance with other embodiments, the TRRP position may be defined as an offset with respect to the NG-RAN access point specified. This may be a vector in three dimensions with the NG-RAN position as the origin.

In accordance with yet other embodiments, the information may also be embedded into respective INFORMATION REQUEST and INFORMATION RESPONSE messages accordingly for other positioning methods such as NR-DL-TDOA, NR-UL-TDOA, NR-Multi-RTT. More specifically, the TRRPPositionList may appear at the same IE level as the NG-RAN position IE appears within the concerned method.

For a TRP which is hosted within a DU, the F1-AP interface between the gNB-CU and gNB-DU (see FIG. 2) may be used to provide the TRP information using an IE TRP Information.

At the same IE level containing the NR-RAN Access Point Position, the TRRPPositionList shown above may be added and signaled as optional parameter to the LMF.

One way the LMF may deduce the capabilities of the receiver/transmitter at the network side is the presence or absence of the optional phase center information. If the phase center information is missing in the signaling, then it is to be deduced that the TRP does not support the TRRP reporting feature.

For a UE-based positioning, the location of TRRPPosition is to be made available to the UE. The LMF may transfer this information using the message Provide Assistance Data either on request from the UE using the message Request Assistance Data or unsolicited. However, the location of TRRP may be needed at multiple UEs performing UE-based positioning. In this situation, the TRRP location may also be conveyed by broadcasting positioning SIBs, posSIBs, via RRC signaling.

TRRP Accuracy—Normal and Enhanced Modes of TRRP Information Reporting

In accordance with embodiments, an equipment, like a gNB, a UE, an IAB node, etc., is capable of providing information that describes its phase center or TRRP 202 (see FIG. 3) and/or its timing reference point 200 (see FIG. 3). The equipment may provide this information be sending a report using, e.g., of or more of the following:
direct or indirect reporting, e.g., a gNB or a UE may send a report directly to another network entity, an IAB node might send its report indirectly, for example from one IAB node to the next;
relative or absolute reporting as described, for example, in connection with relative and absolute information, e.g., position;
requested, timed, repeated, sequenced, scheduled, delayed, continuous or intermittent reporting;
raw (uncorrected) or corrected reporting, e.g., the positioning information sent in the report can be “raw” or “uncorrected” or “uncalibrated” in the sense that it has not been corrected according to some other type of reference measurement or calibration routine. The result of the latter thus provides “corrected” or “calibrated” positioning reports;
uncalibrated or calibrated reporting, e.g., a, a calibration may provide for a comparison of one quantity with another and from which a correction can be determined. In the case of a certified report, the calibration procedure is somehow qualified or certified, for example by a test house;
uncertified or certified reporting;
non-traceable or traceable reporting, e.g., the calibration procedure may not only be certified but is also based on quantities that are traceable, for example to a regulated standards laboratory such as DIN, NF, BSI, NIST, etc;
reporting associated with category, class, quality and authenticity, e.g., it is possible that all devices may have different qualities or authenticities of reporting information. Devices may thus have the means to indicate or report such “class” or “category” information;
reporting associated with a type of signal, a logical or physical channel, or a layer.

Certain equipment, depending on its class/category/capability, is able to provide phase center and/or timing reference point information using more than one reporting mode. In accordance with embodiments, as a minimum requirement, an equipment provides normal reporting. An equipment is assumed to have the means to reveal its capabilities to other equipment, either automatically, or when requested, or when authorized.

Normal Reporting

In accordance with embodiments normal reporting may be employed, and the equipment provides information that describes or defines its phase center/TRRP 202 and/or its timing reference point 200. This information may be provided as part of a manufacturer's declaration, and may be given with respect to a set of specific or fixed operating conditions, for example one or more of:
a fixed operating frequency, e.g., the center frequency of a given NR operating band;
a fixed beam direction, e.g., the boresight or the direction in which all beamforming weights are reset so as not to electronically scan the beam away from the boresight;
a fixed polarization, e.g., a single polarization such as a vertical, a horizontal, a left-hand circular or a right-hand circular polarization.

The set of specific or fixed operating conditions for which the phase center and/or its timing reference point is given may form part of the aforementioned set of information, or may be provided to other devices through signaling.

Enhanced Reporting

In accordance with embodiments enhanced reporting may be employed, and the equipment provides information that describes or defines its phase center/TRRP 202 and/or its timing reference point 200. Unlike normal reporting, this information is provided for the equipment's current operating conditions rather than for a set of specific or fixed operating conditions. For example, the current operating conditions may be described by a set of parameters that include one or more of:
the current frequency of operation;
the current beam direction;
the current polarization.

The enhanced reporting may provide absolute information describing or defining a phase center/TRRP 202 and/or a timing reference point 200.

In accordance with embodiments instead of providing the absolute information or in addition thereto, the equipment may provide information that describes or defines its phase center/TRRP 202 and/or its timing reference point 200 with reference to information the equipment may provide through normal reporting. This form of reporting provides relative information. For example, normal reporting may define the phase center/TRRP as a triple of absolute coordinates {x₀, y₀, z₀}, while the relative reporting may provide a triple of relative coordinates {x₁, y₁, z₁}. The phase center/TRRP for a current operating condition is then determined by suitably combining the two coordinate sets. It is noted that an example has been given using a set of Cartesian coordinates, however, other forms of three-dimensional coordinate representations are not excluded, for example spherical coordinates and cylindrical coordinates may be used as well.

Requested Reporting

In accordance with embodiments, an equipment operating in certain conditions or use cases or applications may require different levels of accuracy in order to determine its position. FIG. 14 illustrates the concepts of accuracy, precision and trueness. The terms accuracy, trueness and precision are differentiated terms when referring to measurements in the scientific and technical context. Generally speaking, accuracy refers to how close a measured value is in relation to a known value or standard. However, the International Organization for Standardization (ISO) uses “trueness” for the above definition while keeping the word “accuracy” to refer to the combination of trueness and precision. On the other hand, precision is related to how close several measurements of the same quantity are to each other. In the field of statistics, it is rather common to use the terms “bias” and “variability” to refer to the lack of “trueness” and the lack of “precision” respectively. The ISO standard 5725, under the title “Accuracy (trueness and precision) of measurement methods and results”, uses the combination of two terms, “trueness” and “precision” of FIG. 14 to describe the accuracy of a measurement method. According to ISO 5725, “Trueness” refers to the closeness of agreement between the arithmetic mean of a large number of test results and the true or accepted reference value as may be seen in ISO 5725-1:1994. Accuracy (trueness and precision) of measurement methods and results—Part 1: General principles and definitions. 1994. “Precision” refers to the closeness of agreement between different test results.

The words accuracy, trueness and precision are important differentiated terms when referring to measurements in the scientific and technical context. Generally speaking, accuracy refers to how close a measured value is in relation to a known value or standard. However, the International Organization for Standardization (ISO) uses “trueness” for the above definition while keeping the word “accuracy” to refer to the combination of trueness and precision. On the other hand, precision is related to how close several measurements of the same quantity are to each other. In the field of statistics, it is rather common to use the terms “bias” and “variability” to refer to the lack of “trueness” and the lack of “precision” respectively. The ISO standard 5725, under the title “Accuracy (trueness and precision) of measurement methods and results”, uses the combination of two terms, “trueness” and “precision” (FIG. 14), to describe the accuracy of a measurement method. According to ISO 5725, “Trueness” refers to the closeness of agreement between the arithmetic mean of a large number of test results and the true or accepted reference value [1]. “Precision” refers to the closeness of agreement between different test results.
1. ISO 5725-1:1994. Accuracy (trueness and precision) of measurement methods and results—Part 1: General principles and definitions. 1994. https/Avww.iso.org/obp/ui/#iso:std:iso:5725:-1:ed-1:v1:en

On the other hand, the Bureau International des Poids et Mesures (BIPM) defines accuracy as the closeness of agreement between a measured quantity value and a true quantity value of a measurand (quantity intended to be measured) as may be seen in BIPM, Joint Committee for Guides in Metrology (JCGM), Working Group on the International Vocabulary of Metrology (VIM). Intemational vocabulary of metrology—Basic and general concepts and associated terms (VIM), JCGM 200:2012. In this case, trueness is defined as the closeness of agreement between the average of an infinite number of replicate measured quantity values and a reference quantity value. Equivalently, the New Oxford American Dictionary gives the technical definition of accuracy as the degree to which the result of a measurement, calculation, or specification conforms to the correct value or a standard, see In the New Oxford American dictionary (3rd Edition). In the same line, the Merriam-Webster dictionary defines accuracy as the degree of conformity of a measure to a standard or a true value, see In the Merriam-Webster's dictionary (Nez Edition). 2016.

As notated by the BIPM, historically, the term “measurement accuracy” has been used in related but slightly different ways. Sometimes a single measured value is considered to be accurate, when the measurement error is assumed to be generally small. In other cases, a set of measured values is considered to be accurate when both the measurement trueness and the measurement precision are assumed to be good. Care must therefore be taken in explaining in which sense the term “measurement accuracy” is being used. There is no generally established methodology for assigning a numerical value to measurement accuracy. In statistics, trueness is generally referred as lack of bias which is defined as the difference between an estimator's expected value and the true value of the parameter being estimated. In some experimental cases, some external factors may change the measured value introducing a bias. The bias is defined as the difference between the mean of the measurements and the reference value. In general, the measuring instrument calibration procedures should focus on establishing and correcting it.

Thus, for certain use cases it may be sufficient for the equipment to use normal reporting, e.g., a device that is not moving so much nor has triggered any “special” event. On the other hand, other use cases, like a scenario in which after a user or a device has sent a distress call—for example, a “911” call-emergency services may require the device to provide more accurate reporting information so that the user/device can be found with less “searching” and thus more quickly. A second example is tracking the position of lost or stolen goods—for example a tracker fitted to a vehicle, may require the equipment to implement enhanced reporting. In such circumstances, an equipment or device may be equipped with means to either directly request enhanced reporting information from another device and/or first determine through an exchange of signaling information, whether the device has the capability of providing the enhanced reporting information.

Whether normal, enhanced or requested reporting is used may be signaled using IE trrpReportingCapability illustrated in FIG. 8.

TRRP Signaling

Embodiments for signaling the TRRP in accordance with the inventive approach are now described in more detail.

In accordance with a first embodiment, the TRRP position may be signaled from a BS to an LMF (see FIG. 2), for example for network positioning, like UTDOA or DOA measurements at the BS. For this the NRPPa may be used.

In accordance with a second embodiment, the TRRP position may be signaled from a UE to an LMF (see FIG. 2), for example for UE assisted positioning, like OTDOA. For this the LPP may be used.

In accordance with a third embodiment, the TRRP position may be signaled from an LMF to a UE or to the network, like a BS, for UE or network only position calculation.

The signaling in accordance with the first to third embodiments described above, may also provide an update of the TRRP position with reference to a previous position. The TRRP may be signaled either as one or more coordinates of a reference coordinate system, e.g., a GNNS coordinate system, or with reference to a static reference point in the device, e.g., an antenna connector or an antenna position. The coordinates may be Cartesian, spherical or any other format. A coordinate reference system is defined for example in [3GPP18-23032].

The TRRP location may be signaled from the UE to the LMF using the ProvideLocationInformation message. In accordance with embodiments, the existing IE NR-DL-TDOA-ProvideLocationInformation may be extended by adding the TRRP information as shown in FIG. 15. The nr-DL-TDOA-TRRPInformation may be provided as an offset to a reference point at the UE. The reference point may be, for example, the antenna or antenna connector that is currently considered as a reference point for measurements. This may be specified as a combination of length and Euler angles or as a Quaternion. This information may be applied accordingly to other positioning methods.

TRRP correspondence for transmitting/receiving spatially filtered signals for positioning Embodiments for providing the TRRP are now described in more detail for a downlink, DL, scenario and an uplink, UL, scenario. In the following description, the TRPs and beams are those illustrated in FIG. 2.

DL case:
a) The TRPs (see TRP₁-TRP₃ in FIG. 2) are configured in transmission mode with different precoders or beamformers or spatial filters and corresponding antenna ports which define which physical antennas are used for transmitting the spatially filtered signals, like the Synchronization Signal Block, SSB, the PRS, the CSI-RS or the demodulation reference signal, DM-RS, using the transmit beams 1, 2 and 3 on TRP₁, the transmit beams 4, 5 and 6 on TRP₂ and the transmit beams 7,8 and 9 on TRP₃.
   i) The transmitter computes or derives, e.g., from a look up table, LUT, the phase center or TRRP of the transmitted spatially filtered signal, e.g., the geometrical mean of the contributing antenna element positions.
   ii) The phase center information per Tx Beam is provided to a positioning device, like the LMF for a UE-assisted mode or the UE for a UE-based mode. The information may include the gNB-ID or TRP-ID, the beam-ID and the TRRP information for the transmitted beams. For example, the information may be provided as: TRP-Index #N, PRS-Index #K, TRRP information.
b) The receiver, the UE for the DL scenario, may receive the DL reference signal using receive beams defined by different precoders or beamformers or spatial filters, as illustrated by the RX beams A, B and C in FIG. 2.
   i) The receiver computes or derives, e.g., from a LUT, the phase center/TRRP of the received spatially filtered signal, e.g., the geometrical mean of the contributing antenna element positions.
   ii) The information may include the TRP-Index #N, the PRS-Index #K and the TRRP information for the received beams.

UL case:
a) The TRPs (see TRP₁-TRP₃ in FIG. 2) are configured in reception mode with different spatial filters and corresponding antenna ports which define which physical antennas are used for receiving the spatially filtered signals, namely beams 1, 2 and 3 on TRP₁, beams 4, 5 and 6 on TRP₂ and beams 7, 8 and 9 on TRP₃ to receive an UL signal transmitted from for the UE, for example a SRS.
   i) The receiver computes or derives, e.g., from a LUT, the TRRP of the received spatially filtered signal, e.g., the geometrical mean of the contributing antenna element positions.
   ii) The TRRP information per Rx Beam is provided to a positioning entity, like an LMF for UE-assisted mode or a UE for UE-based mode.
      The information may include the gNB-ID or TRP-ID, the beam-ID and the TRRP information with respect to the received beams. For example, the information may be provided as:
      TRP-Index #N, PRS-Index #K, TRRP information, or
      a reporting per UL measurement ID including the SRS-ID, the beam-ID and the TRRP information, or
      a relative of arrival measurement report including the RTOA-ID, the beam-ID and the TRRP information.
b) The transmitter, the UE for the UL scenario, may transmit the UL reference signal with different spatial filters, see Tx beams A, B and C in FIG. 2.
   i) The transmitter computes or derives, e.g., from a LUT, the TRRP of the transmitted spatially filtered signal, e.g., the geometrical mean of the contributing antenna element positions.
   ii) The information may include
      the SRS-Index #N and the TRRP information for the transmitted beams, or
      if a spatial relation is configured per DL signal, the gNB-ID or TRP-ID, the beam-ID and the TRRP information.

TRRP Related Procedure for LMF-Based TDOA

An embodiment for an LMF-based TDOA using the signaled TRRP is now described as it may be implemented in a system as described in FIG. 2.
(1) The LMF determines that PRS resources or resource sets received from a gNB have different spatial relation information. The LMF may request the gNB/TRP to provide information on its type.
   (1a) The LMF sends an NRPPa ASSISTANCE DATA REQUEST message to the gNB that indicates that phase center or TRRP information data is requested, and/or
   (1b) The LMF sends an NRPPa ASSISTANCE DATA REQUEST message to the gNB that indicates that the gNB type is requested.
(2) The gNB provides the requested TRRP information in an NRPPa ASSISTANCE DATA RESPONSE message, if available at the gNB. If the gNB is not able to provide any information, it returns an ASSISTANCE DATA FAILURE message indicating the cause of the failure. In addition or instead, the gNB may provide information of its type, e.g., 1-H or 1-C, the latter indicating to the LMF about the TOA error resulting from the uncertainty in defining the phase center.
(3) The LMF sends to the target device assistance data on PRS measurements over the LPP interface with an LPP Provide Assistance Data message and asks the target device to perform measurements with an LPP Request Location Information message.
(4) The target device performs the timing measurements, RSTD measurements. The RSTD measurements may include a timing error resulting from the phase center/TRRP mismatch with the antenna coordinates.
(5) The target device provides the LPP Location Information to the LMF.
(6) The LMF uses the information provided in step (1) by the gNB(s) and the measurements provided by the target device in step (5) to compute the target device position.

TRRP Related Procedure for UE-Based DL-TDOA

An embodiment for a UE-based DL-TDOA using the signaled TRRP is now described as it may be implemented in a system as described in FIG. 2.
(1) The LMF determines that PRS resources or resource sets received from a gNB have different spatial relation information. The LMF may request the gNB/TRP to provide information on its type.
   (1a) The LMF sends an NRPPa ASSISTANCE DATA REQUEST message to the gNB that indicates that phase center or TRRP information data is requested, and/or
   (1b) The LMF sends an NRPPa ASSISTANCE DATA REQUEST message to the gNB that indicates that the gNB type is requested.
(2) The gNB provides the requested TRRP information and/or type information in an NRPPa ASSISTANCE DATA RESPONSE message, if available at the gNB. If the gNB is not able to provide any information, it returns an ASSISTANCE DATA FAILURE message indicating the cause of the failure.
(3) The LMF sends to the target device assistance data on PRS measurements over the LPP interface with an LPP Provide Assistance Data message including the TRRP information or gNB type information.
(4) The target device performs the timing measurements, RSTD measurements, and, using the information provided in step (1) by the gNB(s), computes its own position

TRRP Related Procedure for UL-TDOA

An embodiment for an UL-TDOA using the signaled TRRP is now described as it may be implemented in a system as described in FIG. 2.
(1) The LMF determines that UL-PRS, like SRS, resources or resource sets received from a gNB have different spatial relation information.
   (1a) The LMF sends an NRPPa ASSISTANCE DATA REQUEST message to the gNB that indicates that phase center or TRRP information data is requested, and/or
   (1b) The LMF sends an NRPPa ASSISTANCE DATA REQUEST message to the gNB that indicates that the gNB type is requested.
(2) The gNB provides the requested TRRP information and/or type information in an NRPPa ASSISTANCE DATA RESPONSE message, if available at the gNB. If the gNB is not able to provide any information, it returns an ASSISTANCE DATA FAILURE message indicating the cause of the failure.
(3) The LMF uses the information provided in step (1) by the gNB(s) and the RTOA measurements provided by the TRP to compute the target device position

TRRP Reporting Frequency

In accordance with embodiments, TRRP reporting may be coupled to a positioning measurement request and may be periodic or a-periodic, e.g., the TRRP may be reported on demand or request.

For example, in case of TOF based measurements, a TRRP update requires an unambiguous correspondence to the measurement report. For example, if an OTDOA measurement report is sent to determine the position of a UE, the TRRP position or TRRP position update is either send together with the measurement or send separately with a unique index pointing to this OTDOA measurement. The same holds for DOA measurements.

In case of spatially filtered signals, e.g. for uplink positioning using SRS, which are precoded using a codebook, and for downlink positioning using PRS, which are precoded using a codebook, the TRRP may be signaled with reference to a codeword, like an entry in the a codebook, or with reference to a previous used signal, e.g. by utilizing the QCL Type D correspondence. By reusing a previous codeword or spatial filter a TRRP update may not be required, however the explicit correspondence of the TRRP to the measurement is given.

It is noted that also spatially filtered signals other than PRS and SRS may be used for determining a position, e.g. CSI-RS, DM-RS or PTRS.

For UE specific spatially filtered signals the TRRP report is to be updated. For example in the downlink the BS may select a non-codebook precoder for a UE or a specific group of UEs, and in the uplink a non-codebook precoder is selected by the UE for SRS. It is noted that this may also include that the TRRP has not changed when compared to a previous TRRP report.

The above description assumes that when discussing spatially filtered signals the TRRP parameters other than those indicated remain constant, like carrier frequency, transmit power or the antenna mode. If not, these changes need also to be signaled. For example, a change of transmit power may be caused due to adaptive power control at the UE, e.g. as in a path-loss dependent open-loop power control for uplink transmissions.

TRRP Storage

In accordance with embodiments, a received TRRP may be stored, e.g., to be reused later.

The TRRP may be associated to certain signals or spatial filters, e.g., in case of a codebook-based transmission, the TRRP information per codeword may be exchanged only once. In case multiple codewords in the codebook are associated with the same TRRP even less than the overall number of codewords needs to be exchanged. In case the same antennas and spatial filter are used twice for different signals, e.g. for SSB and later for PRS, the TRRP sent along with the SSB may be reused for the PRS, e.g. signaling the QCL Type D correspondence of PRS with SSB according to [3GPP19-38214]. In such a case the TRRP stores the correspondence with the gNB-ID or TRP-ID and beam-ID in the LMF.

The location and direction information about the radiation reference point or TRRP may be stored or calculated or provided at/from:
the LMF, Location Management Function, and the AMF, Access and Mobility Function, and the associated data base(s).
the eNB/gNB, like base stations, reference TRPs, relay nodes (e.g., Decode & Forward and Repeat, Amplify & Forward, IAB nodes). In case of moving NG-RAN nodes (gNBs or TRPs), the TRRP position may be regularly updated.
the UE or user device.

For exchange of TRRP data, embodiments may use the following procedures:
embedding the TRRP data explicitly or implicitly in a DCI of the base station,
signaling the TRRP data in the over the top, OTT, channel connected to a data base, e.g. in the internet, and providing additional information about other networks or nodes providing reference signals which may be used for positioning.

The additional positioning relevant TRRP information may be provided using existing file and data formats that are extended to make room for the additional TRRP information described herein.

Transmission and Reception Reference Information

In accordance with the embodiments described above, the TRRP is signaled, however, the present invention is not limited to such embodiments. In accordance with further embodiments, Transmission and Reception Delay, TRD, information may be signaled in addition to the TRRP information.

In accordance with embodiments, rather than signaling the TRRP, Transmission and Reception Reference Information, TRRI, is signaled, which includes the TRRP and TRD information as described in more detail below. In accordance with embodiments, the above described approaches for signaling the TRRP may be used for signaling the TRRI.

TRRI Definition:

In accordance with embodiments, the Transmission and Reception Reference Information, TRRI includes:
the TRRP, and
the transmission and reception delay, TRD, information. The TRD may include information on the signal delay between the TRRP and the baseband unit, and/or delay information about one more of the following: a transceiver unit, TXRU, delay, a transceiver array boundary, a radio distributed network, a physical antenna array However, although it is possible to provide delay information, with the apparatus on specific components, alternatively or in addition, the delay information can be determined by the apparatus between ideally between the TRRP and the baseband unit, e.g., the apparatus can provide information on the way the TRD information were determined, e.g., by indicating one or more of:
   Tx/Rx TRRP
   Tx/Rx antenna connector
   Tx/Rx antenna
   Tx/Rx Transceiver Array Boundary connector.
The LMF Location Management Function, may make use of these information to determine the uncertainty of the measurements.

Adjustments of the TRD (Transmission Reception Delay)

In accordance with embodiments, the TRD may provide delay information per UE or per TRP beam index or per TX/Rx spatial filter. The TRD may be determined by a positioning node, which may be a gNB, a TRP or a UE using, in accordance with embodiments, an offline calibration or a triggered or online calibration.

Offline calibration: the transceiver delays are calibrated in an offline session, i.e., not during a positioning session. The TRD information is then provided as a LUT which may be saved on the positioning node. The information may include dependencies on delay influencing factors for example the temperature, operating frequency, and spatial filters used for delay calibration.

Triggered or Online calibration: the transceiver delays are calibrated by a network, NW, trigger or online during a positioning session. The apparatus determines the TRD information based on a positioning reference signal measured at the device.

In accordance with embodiments, the positioning node may measure a loopback delay a signal travels to estimate the overall transceiver delays (Tx, Rx).

TRRP to TRRP Loopback

In accordance with embodiments, the loopback signal may be measured from a first transmit TRRP to a second receive TRRP where each TRRP is associated with a different antenna panel of the same device or positioning node.

However, for measurements in the high frequency range, like FR2, the loopback signal is within the near field range, and an operation in this range may lead to an unpredictable performance. In other words, in such a scenario, determining the loopback delay may be difficult or not possible at all. Therefore, in accordance with embodiments, the loopback operation is limited to ranges or distances between the TRRPs that are above a certain range R. Where R defines the minimum range for determining a TRD between two TRRPs or two antennas; where R can be indication of the near field or reactive near field region for an antenna radiating pattern; where R depends on the wavelength λ and the Antenna length or diameter, the distance separating the two TRRPs or physical antennas and a factor X, where X may have values in the range between X=0.01 and X=3:

$$R > X \frac{{D}^{2}}{λ}$$

$$or$$

$$R > X \sqrt{\frac{{D}^{3}}{λ}}$$

wherein X is a scaling factor. For example, for determining the radiating near field the value of X may be set to 2 but this can be relaxed for TRD determination.

In accordance with embodiments, the positioning node performing an antenna-to-antenna loopback is not expected to use a Tx-RX spatial filter pair of the same device for determining the loopback delay within the range of R. This may allow to avoid TRD measurements in the range <R were the signal is not guaranteed to be received.

Transceiver Loopback

In accordance with other embodiments, the loopback signal may be measured or obtained from the transceiver delay and not from the antenna. The positioning node may implement a calibration delay where the transmitted signal is attenuated and received at the receiver with the same spatial relation of the transmitted signal. The loopback may be realized by measuring the signal received from the Tx/Rx switch or by implementing a dedicated loopback line installed before the transceiver array boundary connector. For example, the positioning node may use information from an offline calibration to compute the overall delay including the transceiver-antenna delays.

In the following a process for determining and reporting the TRD in accordance with embodiments is described. The process may be implemented in a network as depicted in FIG. 2.
1. A NW entity, like the LMF, requests, e.g., over higher layer signaling, from one or more positioning nodes to signal the capability for a TRD determination.
   The one or more positioning nodes report the TRD capability to the NW entity
2. The NW entity configures a positioning node to perform a positioning method, like AoD, DL-TDOA, UL-TDOA, AoA, multi-RTT, as defined in [3GPP TS38.305v16.0.0]or a sidelink method.
3. The NW entity requests the delay information with a higher layer parameter NRPPa provide_TRD_infromation for a TRP or LPP provide_TRD_infromation for a UE.
4. The positioning node reports the TRD delay information using, e.g., a TRRI message which includes, in as an alternative or in addition to the TRRP, the TRD delay information for the spatial filters used for a transmission and/or reception of UL or DL positioning reference signals for the method configured in step 2.
   The positioning reference signal may be a SRS, a PRS, a CSI-RS, a SSB, a sidelink PRS or any other reference signal employed for positioning.
   The reported delays are selected based on the one or more Tx spatial filters used to transmit one or more of the positioning reference signals and/or on the one or more Rx spatial filters used to perform a measurement on the positioning reference signals.
      The measurements may be a RTOA, RSTD, UE Rx-Tx, gNB Rx-Tx or any timing related measurement.

In accordance with embodiments, the above described process or procedure may be used for reporting TRRP.

The above described process or procedure is advantageous. More specifically, without mapping the TRRI report to the measurements and transmitted signals, the NW entity does not have information on the spatial filters and antennas used so that the TRRI information is ambiguous to the NW entity. This ambiguity is avoided by the above-described procedure, more specifically by implementing the reporting procedure in step 4 which provides the positioning node with information on the different delays.

The reporting procedure in step 4, in accordance with embodiments, may depend on whether step 2 configures a DL and UL based positioning method, a DL based positioning method, or an UL based positioning method.
If the method configured in step 2 is a DL and UL based positioning method, like Multi-RTT or E-CID, the UE performs measurements on the DL-PRS signals transmitted from one or more TRPs. The TRPs perform measurements on the UL-SRS signals transmitted from the same UE.
The positioning node, like a UE or a TRP, reports the RTD as a Tx-Rx delay for the spatial filters used for the transmission and/or reception of the UL or DL positioning reference signal.
In accordance with embodiments, the UE may be configured with an UL-PRS configuration to determine the Tx-Rx delay. The UE may be configured with a measurement gap to perform TRD measurements for the configured UL-PRS signal.
The TRP may be configured with a DL-PRS configuration to determine the Tx-Rx delay.
If the method configured in step 2 is a DL based positioning method, like DL-TDOA, the UE performs measurements on the DL-PRS signal transmitted from one or more TRPs.
In accordance with embodiments, the UE may be configured with an UL-PRS configuration to determine the Rx delay. The UE may be configured with a measurement gap to perform TRD measurements for the configured UL-PRS signal. The Rx delay is determined from the total loopback delay and subtracting the Tx delays based on prior calibration information at the UE.
The Tx delay is determined from the total loopback delay and subtracting the Rx delays based on prior calibration information at the TRP.
If the method configured in step 2 is an UL based positioning method, like UL-TDOA, the TRP performs measurements on the UL-PRS, like a SRS, signal transmitted from a UE.
In accordance with embodiments, the TRP may be configured with a DL-PRS configuration to determine the Rx delay.
The Rx delay is determined from the total loopback delay and subtracting the Tx delays based on prior calibration information at the TRP.
The Tx delay is determined from the total loopback delay and subtracting the Tx delays based on prior calibration information at the UE.

Signaling of the TRD

In accordance with embodiments, the TRD is indicated explicitly, e.g., by signaling the actual TRD associated with a certain reference signal, RS, or measurement. For example, the actual values for the delay may be signaled.

In accordance with other embodiments, the TRD is indicated implicitly, e.g., by signaling a TRD indication. For example, the TRD may be indicated using one or more TRD identifiers, and each TRD identifier may represent the TRD associated with a certain reference signal, RS, like a positioning reference signal, and/or a certain measurement, like a measurement of a positioning reference signal.

In accordance with embodiments, TRDs of two or more RSs or measurements that have the same TRD or that are similar, e.g., have TRDs that are within a predefined range of TRDs, may be indicated using the same TRD identifier. For example, a TRD information indicating the TRD used to receive one or more DL positioning reference signals or resources or/and one or more UL positioning reference signals or resources may be reported. If two or more positioning reference signals or measurements are reported with the same TRD indication, the position determining processor may assume that the TRD delays are the same or are similar. For example, in case of a DL-TDOA in UE-assisted mode, a UE report to a LMF a TRD-indication, and the LMF may use this information to subtract one or more common TRDs or to estimate the one or more common TRDs.

DL Position Determining Method

In accordance with embodiments, the apparatus for determining a position of an entity of a wireless communication network may be a UE operating in accordance with a DL position determining method. In such a case, the indication comprises at least one or more TRD identifiers, IDs. The identifier indicates the TRD used for the reception of one or more of DL positioning reference signals or resources, where two or more DL positioning reference signals or resources or DL measurements, e.g., the RSTD, the DL Reference Signal Time Difference, DL-RSRP, DL-AoD and the like, reported with the same TRD indication have the same or a similar delay.

In accordance with embodiments, the apparatus for determining a position of an entity of a wireless communication network may be a TRP operating in accordance with a DL position determining method. In such a case, the indication comprises at least one or more TRD identifiers, IDs. The identifier indicates the TRD used for the transmission of one or more of DL positioning reference signals or resources, where two or more DL positioning reference signals or resources reported with the same TRD indication have the same or a similar delay.

UL Position Determining Method

In accordance with embodiments, the apparatus for determining a position of an entity of a wireless communication network may be a TRP operating in accordance with an UL position determining method. In such a case, the indication comprises at least one or more TRD identifiers, IDs. The identifier indicates the TRD used for the reception of one or more of UL positioning reference signals or resources, where two or more UL positioning reference signals or resources or UL measurements, e.g., the Relative Time of Arrival, RTOA, the UL-RSRP, the UL-AoA, and the like, reported with the same TRD indication have the same or a similar delay.

In accordance with embodiments, the apparatus for determining a position of an entity of a wireless communication network may be a UE operating in accordance with an UL position determining method. In such a case, the indication comprises at least one or more TRD identifiers, IDs. The identifier indicates the TRD used for the transmission of one or more of UL positioning reference signals or resources, where two or more UL positioning reference signals or resources reported with the same TRD indication have the same or a similar delay.

UL and DL Position Determining Methods

In accordance with embodiments, the apparatus for determining a position of an entity of a wireless communication network may be a TRP or a UE operating in accordance with UL and DL position determining methods. In such a case, the indication comprises at least one or more TRD identifiers, IDs. The identifier indicates the TRD used for the reception of one or more DL positioning reference signals or resources and the transmission of one or more UL positioning reference signals or resources, where one or more UL positioning reference signals or resources and one or more DL positioning reference signals or resources or DL-and-UL measurements, like Rx-Tx measurements, reported with the same TRD indication have the same or a similar delay.

In accordance with embodiments, the apparatus for determining a position of an entity of a wireless communication network may be a UE implementing a UE-based positioning determining mode. The network or system comprises a LMF to provide the association information of DL PRS resources with TRD to the UE for the UE-based positioning determining. The UE receives one or more indications, and the indication comprises at least one or more TRD identifiers, IDs. The identifier indicates the TRD used for the transmission of one or more of DL positioning reference signals or resources, where two or more DL positioning reference signals or resources reported with the same TRD indication have the same or a similar delay.

Multi Field Indication

In accordance with embodiments, the TRD indication includes for an RSTD measurement one TRD identifier for the reference TRP and one TRD identifier for the measurement TRP. In accordance with embodiments, the indication may include for an UL or DL measurement and for a DL or UL measurement one TRD identifier for the UL transmission and one TRD identifier for the DL reception, or one TRD identifier for the DL transmission and one TRD identifier for the UL reception.

### Further Embodiments

In accordance with further embodiments, the apparatus may be instructed by a higher-layer-interface to provide information on the TRD information. The apparatus may report the TRD information as an indication on the measurements performed with the same or similar within a margin.

In accordance with embodiments, a UE may be configured to simultaneously transmit or/and receive on different frequency parts. The UE may be configured to transmit or/and perform measurements for different usage such as MIMO or positioning usage with specific configuration for each.

If a UE is configured to simultaneously transmit one or more positioning reference signals on a first frequency part and on a second frequency part, the UE may report, subject to the UE capability, if the one or more TRDs for the UL resources on the first frequency part and on the second frequency part are the same or are similar within a certain margin. The UE may report in the TRD information the band indices associated with the UL resources that were used for the UL transmission.

If a UE is configured to simultaneously receive one or more positioning reference signals on a first frequency part and on a second frequency part, the UE may report, subject to the UE capability, if the one or more UE receiver TRDs for the DL measurements on the first frequency part and on the second frequency part are the same or are similar within a margin. The UE may report in the TRD information the band indices associated with the DL resources that were used, e.g., for the one or more RSTD measurements.

If a UE is configured to simultaneously receive one or more positioning reference signals on a first frequency part and on a second frequency part, the UE may receive from the network information on the TRP transmitter TRDs for the DL resources on the first frequency part and on the second frequency part. The UE may apply this information to process a time of arrival or direction arrival estimation on the reference signal received from the two frequency parts.

If a UE is configured to simultaneously transmit one or more positioning reference signals on a first frequency part and on a second frequency part, and if the UE is configured to receive on the first and/or second frequency parts, the UE may report in the TRD information the band indices associated with the UL resources that were used for the Rx-Tx measurement.

It is noted that the above mentioned frequency parts may refer to a band, a component carrier, inter-band carriers, intra-band carriers, one or more bandwidth parts, a frequency layer or a frequency range.

In accordance with embodiments, the UE may be configured to transmit one or more RSs at different time instants. The UE, depending on the channel conditions and the UE constraints, may apply different Tx filters on the same configured RSs. The TRD may change when the UE applies different Tx settings. The UE may provide one or more time information within one or more measurement reports for the provided TRD information.

In the same scenario, the LMF in UE-assisted mode or the UE in UE-based mode may receive from the TRP one or more measurements the one or more RSs. The one or more TRP measurements may include time information on the different time instants. The TRP may provide one or more time information within one or more measurement reports for the provided TRD information. The LMF or the UE may map the TRD information received from the UE or measured by the UE with the one or more TRP measurement report information at one or more time instants from one or more reports. The TRP may provide the UE or the LMF with one or more timestamps for the provided TRD information within one more measurement reports.

In accordance with embodiments, the UE may be configured to receive one or more RSs at different time instants. The UE, depending on the channel conditions and the UE constraints, may apply different Rx filters on the same configured RSs. The TRD may change when the UE applies different Rx settings. The UE may provide one or more timestamps for the provided TRD information within one or more measurement reports.

In one example, the measurement report may include the timestamps when the provided TRD information are valid.

In one example, the TRD information including an indication value may only apply on the same measurement report unless otherwise indicated. Thus, the TRD indication may not be directly mapped on a UE or the TRP physical transmitter or/and receiver chain.

General

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

In accordance with the embodiments described above, the TRRP is signaled. In accordance with further embodiments, additional information may be signaled, like a field of view or opening angle of an array, a steering range for beams, a main direction of an array and/or specific beams.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 16 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

| Reference Label | Details |
|---|---|
| [3GPP18-23032] | 3GPP, 23032 V15.1.0 (2018-09) “Universal Geographical Area Description |
| | (GAD), Release 15”, 3rd Generation Partnership Project |
| [3GPP18-22.804] | 3GPP TR 22.804 V16.2.0 (2018-12) “Study on Communication for Automation in |
| | Vertical Domains (CAV)” |
| [3GPP19-22.261] | 3GPP TS 22.261 V17.1.0 (2019-12) “Service Requirements for the 5G system” |
| [3GPP19-37355] | 3GPP, TS 37.35.355 V15.0.0 (2019-12) “LTE Positioning Protocol (LPP), Release 15” |
| [3GPP19-38141] | 3GPP TS 38.141-2 V16.2.0 (2019-12) “Base Station (BS) conformance testing |
| | Part 2: Radiated conformance testing” |
| [3GPP19-38211] | 3GPP TS 38.211 V16.0.0 (2019-12) “Physical channels and modulation” |
| [3GPP19-38214] | 3GPP TS 38.214 V16.0.0 (2019-12) “Physical layer procedures for data” |
| [3GPP19-38215] | 3GPP TS 38.214 V16.0.0 (2019-12) “Physical layer measurements” |
| [3GPP19-38305] | 3GPP TS 38.305 V15.5.0 (2019-12) “User Equipment (UE) positioning in NG-RAN” |
| [3GPP19-38455] | 3GPP TS 38.455 V15.2.1 (2019-01) “NR Positioning Protocol A (NRPPa)” |
| [3GPP20- RP-193237] | 3GPP RP-193237 Release 17 (2019-12) “Study Item Description NR Positioning” |
| [AH20] | S. A. Almasri and P. A. Hoeher, “Impact of Phase Center Displacement on |
| | Direction-of-Arrival Estimation using Multi-Mode Antennas”, Proceedings of 24th |
| | International ITG Workshop on Smart Antennas (WSA), 2020 |
| [Bal67] | M. Balfour, “Active impedance of a phased-array antenna element simulated by |
| | a single element in waveguide”, IEEE Transactions on Antennas and |
| | Propagation, 1967. vol. 15, pp. 313-314 |
| [CGS + 04] | J. Campbell, B. Görres, M. Siemes, J. Wirsch and M. Becker, “Zur Genauigkeit |
| | der GPS Antennenkalibrierung auf der Grundlage von Labormessungen und |
| | deren Vergleich mit anderen Verfahren”, Allgemeine Vermessungs-Nachrichten |
| | (AVN), 2004, vol. 111, pp. 2-11 |
| [FBCF19] | J. M. Felicio, J. M. Bioucas-Dias, J. R. Costa and C. A. Fernandes, “Antenna |
| | Design and Near-Field Characterization for Medical Microwave Imaging |
| | Applications”, IEEE Transactions on Antennas and Propagation, 2019, vol. 67, |
| | pp. 4811-4824 |
| [IEEE13-IEEEStd145- | IEEE, “IEEE Standard for Definitions of Terms for Antennas”, Institute of Electrical |
| 1993] | and Electronics Engineers, Institute of Electrical and Electronics Engineers, 2013 |
| [GFWWE11] | T. von der Grün, N. Franke, D. Wolf, N. Witt and A. Eidloth, “A real-time tracking |
| | system for football match and training analysis,” in Microelectronic systems, |
| | Springer, 2011, pp. 199-212. |
| [HGC16] | D. Harke, H. Garbe and P. Chakravarty, “A new method to calculate phase center |
| | locations for arbitrary antenna systems and scenarios”, 2016 IEEE International |
| | Symposium on Electromagnetic Compatibility (EMC), 2016, pp. 674-678 |
| [LAS + 18] | P. S. H. Leather, R. Askar, K. Sakaguchi, T. Haustein and L. Raschkowski, |
| | “METHODS AND MEASUREMENT SYSTEMS FOR PRECISELY EVALUATING |
| | A DEVICE UNDER TEST”, WO2018229217, 2018 |
| [NR17] | A. Nafe and G. M. Rebeiz, “On the phase center analysis of linear phased-array |
| | antennas”, International Symposium on Antennas and Propagation USNC/URSI |
| | National Radio Science Meeting, 2017, pp. 2023-2024 |
| [Qur19] | Qorvo, “30 GHz 5-bit digital phase shifter”, Qorvo datasheet TGP2100, April |
| | 2019, URL: https://www.qorvo.com/products/d/da005059 |
| [R4-1915801] | Q. Guo and I. Siomina, “Response LS on Reference Point for Timing Related |
| | Measurements in FR2”, 2019 |
| [RHJDM15] | T. S. Rappaport, R. W. Heath Jr, R. C. Daniels and J. N. Murdock, “Millimeter |
| | wave wireless communications”, Pearson Education, 2015 |
| [Vis06] | H. J. Visser, “Array and phased array antenna basics”, John Wiley & Sons, 2006, |
| [Wik20] | Wikipedia, “Beamforming”, Online, edited on 28 Feb. 2020, accessed 27 Apr. 2020, |
| | https://en.wikipedia.org/wiki/Beamforming |
| [WRP20] | https://white-rabbit.web.cern.ch/ |
| [Zei11] | P. Zeimetz, “Zur Entwicklung und Bewertung der absoluten GNSS- |
| | Antennenkalibrierung im HF-Labor”, Rheinische Friedrich-Wilheims-Universität |
| | Bonn, Landwirtschaftliche Fakultät, 2011 |

| Abbreviation | Definition | Further Description |
|---|---|---|
| 3GGP | third generation partnership project | |
| 5GC | 5G core network | |
| BS | base station | |
| CSI-RS | channel state information referenc signal | |
| DMRS | demodulation reference signal | |
| DOA | direction of arrival | |
| E-CID | enhanced cell ID | |
| eNB | evolved node b | |
| E-SMLC | evolved serving mobile location center. | |
| E-UTRA | evolved UMTS terrestrial radio access | |
| gNB | next generation node-b | |
| GPS | Global Positioning System | Using satellites as reference points |
| LMF | location management function | |
| LMU | location measurement unit | |
| LPP | LTE positioning protocol | |
| LTE | Long-term evolution | |
| NG | next generation | |
| ng-eNB | next generation eNB | node providing E-UTRA user plane and control plane protocol |
| | | terminations towards the UE, and connected via the NG |
| | | interface to the 5GC |
| NG-RAN | either a gNB or an ng-eNB | |
| NR | new radio | |
| NRPPa | new radio positioning protocol a | |
| OPC UA | Open Platform Communication Unified Architecture | https://en.wikipedia.org/wiki/OPC_Unified_Architecture |
| OTDOA | observe time difference of arrival | |
| PRS | position reference signal | |
| PTRS | phase tracking reference signal | |
| QCL | quasi colocation | |
| RAN | radio access network | |
| RP | reception point | |
| RSTD | reference signal time difference | |
| RTOA | relative time of arrival | |
| RTT | round trip time | |
| SA | Standalone | |
| SRS | sounding reference signal | |
| TDM | Time Domain Multiplexing | Data packets are multiplexed on time resources to distinguish |
| | | between users/device accessing the shared medium |
| TOF | time of flight | |
| TRP | transmission reception point | |
| TRRP | transmission reception reference point | In literature also known as phase center or radiation |
| | | reference point |
| TSN | Time Sensitive Networks | |
| UE | user equipment | |
| UMTS | universal mobile telecommunication system | |
| WRP | White Rabbit Project | https://white-rabbit.web.cern.ch/ |

The invention claimed is:

1. An apparatus comprising:
a processor circuit; and
a memory circuit, wherein the memory comprises instructions executable by the processor circuit,
wherein the processor circuit is arranged to determine a position of a first entity in a communication network using at least one position measurement(s),
wherein the at least one position measurement(s) are between a position of the first entity and a position of at least one second entity(s),
wherein each of the first entity and at least one second entity(s) comprise at least one antenna(s),
wherein the at least at least one antenna(s) are arranged to transmit and/or receive a radio signal for the position measurement,
wherein the processor circuit is arranged to determine the position of the first entity using a transmission reception reference point of the radio signal at the at least one antenna(s) of the first entity and/or the at least one antenna(s) of the at least one second entities, and
wherein the processor circuit is arranged to determine the position of the first entity using transmission and reception delay information,
wherein the transmission and reception delay information comprises information on the signal delay between the transmission reception reference point and a baseband circuit.

2. (canceled)

3. An apparatus comprising:
a processor circuit;
a memory circuit, wherein the memory comprises instructions executable by the processor circuit; and
at least one antenna(s),
wherein the processor circuit is arranged to transmit a transmission reception position and a transmission and reception delay information of the radio signal using the at least one antenna(s),
wherein the transmission reception reference point and the transmission and reception delay information is used for a position determining process,
wherein the transmission and reception delay information comprises information on signal delay between the transmission reception reference point and a baseband circuit.

4. An apparatus comprising:
a processor circuit;
a memory circuit, wherein the memory comprises instructions executable by the processor circuit; and
at least one receive antenna(s), wherein the at least one receive antenna(s) is arranged to receive a radio signal from at least one radio access network entity(s) and/or user devices of a communication network,
wherein the processor circuit is arranged to receive a reception position, a transmission reception reference point, and a transmission and reception delay, transmission and reception delay information of the radio signal,
wherein the radio signal is transmitted by at least one transmit antenna(s) of the radio access network entity(s) and/or user devices,
wherein the transmission and reception delay information comprises information on the signal delay between the transmission reception reference point and a baseband circuit,
wherein the at least one received transmission reception reference point and the transmission and reception delay information are used for a position determining process implemented by the processor circuit or by a network entity,
wherein the network entity is remote from the apparatus.

5. The apparatus of claim 1,
wherein the at least one antenna (s) comprise at least one of a plurality of separate antennas or at least one antenna arrays,
wherein each antenna array comprises a plurality of antenna elements.

6. The apparatus of claim 1, wherein the transmission reception reference point of the at least one antenna(s) is the location from which electromagnetic waves of the radio signal are originating.

7. The apparatus of claim 1,
wherein the transmission reception reference point changes based on a parameter,
wherein the parameter is selected from the group consisting of, a carrier frequency of the radio signal, direction of the beam and/or a power scaling over the at least one antenna(s) when the processor circuit uses a spatial filter, an antenna mode when the at least one antenna(s) comprises a multi-mode antenna and a total output transmit power.

8. The apparatus of claim 1, wherein the transmission reception reference point comprises:
an absolute position; and/or
a position relative to a predefined reference point.

9. The apparatus of claim 1, wherein the transmission reception reference point is associated with first signals or spatial filters.

10. The apparatus of claim 1,
wherein the processor circuit is arranged to signal a capability,
wherein the capability comprises computation of transmission reception reference point for the at least one antenna(s).

11. The apparatus of claim 10,
wherein the processor circuit is arranged to signal the capability based on, to a certain event, like the apparatus accessing the communication network, a deviation of a new transmission reception reference point from a current transmission reception reference point, or a positioning measurement request.

12. (canceled)

13. The apparatus of claim 10, wherein the processor circuit is arranged to signal the transmission reception reference point with respect to a set of operating conditions, an operating frequency, a fixed beam direction and a polarization.

14. The apparatus of claim 10, wherein the processor circuit is arranged is to signal the transmission reception reference point with respect to current operating conditions.

15. The apparatus of claim 13, wherein the processor circuit is arranged is to signal the transmission reception reference point as an absolute position or as position relative to a transmission reception reference point.

16. The apparatus of claim 10,
wherein the processor circuit is arranged to signal the transmission reception reference point with respect to operating conditions, or with respect to current operating conditions,
wherein current operation conditions comprise a frequency of operation.
a current beam direction and a current polarization.

17. The apparatus of claim 10, wherein the transmission reception reference point is signaled in a control message or in an over the top channel connected to a database.

18. The apparatus of claim 1, wherein the transmission reception reference point is stored in at least one of a database associated with a core entity, at least one radio access network entity(s), and an at least one user device(s).

19. The apparatus of claim 1, wherein the transmission reception reference point and the transmission and reception delay information are provided as Transmission and Reception Reference Information.

20. The apparatus of claim 1,
wherein the transmission and reception delay information comprises delay information about a transceiver circuit delay, a transceiver array boundary, a radio distributed network, a physical antenna array, and information on the way the transmission and reception delay information were determined,
wherein the determination comprises a Tx/Rx transmission reception reference point, a Tx/Rx antenna connector, a Tx/Rx antenna, and a Tx/Rx Transceiver Array Boundary connector.

21. The apparatus of claim 1,
wherein the transmission and reception delay information comprises a loopback delay,
wherein the loopback delay is measured from a first transmit transmission reception reference point to a second receive transmission reception reference point,
wherein each transmission reception reference point is associated with a different antenna,
wherein a measurement of the loopback delay is limited to transmission reception reference point outside a certain range R.

22. The apparatus of claim 21, wherein
$$R > X \frac{{D}^{2}}{λ}$$
$$or$$
$$R > X \sqrt{\frac{{D}^{3}}{λ}}$$
wherein λ wavelength of the transmitted or received signal,
wherein R is the minimum range for determining a transmission and reception delay,
wherein D the distance separating the first and second transmission reception reference point,
wherein X a scaling factor in the range between 0.01 and 3.

23. The apparatus of claim 21, wherein, the loopback delay measurement from the first transmit transmission reception reference point to the second receive transmission reception reference point does not use a Tx-RX spatial filter pair for determining the loopback delay within the range of R.

24. The apparatus of claim 1,
wherein the transmission and reception delay delay information reports delays associated with spatial filters used for a transmission and/or reception of uplink or downlink positioning reference signals,
wherein the reported delays are selected based on the at least one Tx spatial filters used to transmit at least one of the positioning reference signals and/or on the at least one Rx spatial filters used to perform a measurement on the positioning reference signals.

25. (canceled)

26. The apparatus of claim 1, wherein the transmission and reception delay is indicated from the group consisting of signaling the actual transmission and reception delay associated with a reference signal or signaling a transmission and reception delay indication.

27. The apparatus of claim 26,
wherein the transmission and reception delay is indicated using at least one transmission and reception delay identifiers,
wherein each transmission and reception delay identifier represents the transmission and reception delay associated with a reference signal, and/or a measurement.

28. The apparatus of claim 27,
wherein the transmission and reception delay is indicated using the same transmission and reception delay identifier when the transmission and reception delay of at least two reference signals or measurements have the same transmission and reception delay or each of the at least two reference signals or measurements have transmission and reception delay that are within a predefined range.

29. The apparatus of claim 27, wherein further comprising a user equipment,
wherein each transmission and reception delay identifier indicates the transmission and reception delay used for the reception or measurement of at least one of downlink positioning reference signals when using a downlink positioning method,
wherein each transmission and reception delay identifier indicates the transmission and reception delay used for the transmission or measurement of at least one of uplink positioning reference signals when using an uplink positioning method.

30. The apparatus of claim 27, further comprising a transmission/reception point,
wherein each transmission and reception delay identifier indicates the transmission and reception delay used for the transmission or measurement of at least one of downlink positioning reference signals, when using a downlink positioning method,
wherein each transmission and reception delay identifier indicates the transmission and reception delay used for the reception or measurement of at least one of uplink positioning reference signals when using an uplink positioning method.

31. The apparatus of claim 27, wherein further comprising a user equipment or a transmission/reception point,
wherein each transmission and reception delay identifier indicates the transmission and reception delay used for the reception of at least one of downlink positioning reference signals and the transmission of at least one uplink positioning reference signals when using both a downlink positioning method and an uplink positioning method.

32. The apparatus of claim 30, wherein the processor circuit is arranged to receive the at least one transmission and reception delay identifiers from a location management functions.

33. The apparatus of claim 29
wherein the uplink positioning or the downlink positioning comprises measurements at a first location and at a second location,
wherein an indication comprises one transmission and reception delay identifier for uplink transmission and one transmission and reception delay identifier for the downlink reception, or one transmission and reception delay identifier for the downlink transmission and one transmission and reception delay identifier for the uplink reception.

34. The apparatus of claim 1, wherein the processor circuit is arranged, to provide information on the transmission and reception delay information based on received instructions.

35. The apparatus of claim 1, wherein the transmission and reception delay information indicates if the transmission and reception delay for the uplink positioning reference signals and/or for the downlink measurements of the downlink positioning reference signals on a first frequency part and a second frequency part are the same or are within a predefined range of transmission and reception delay when transmission and reception delay TRD information is provided by a network entity.

36. The apparatus of claim 35, wherein the transmission and reception delay information comprises band indices of the different frequency parts.

37. The apparatus of claim 1, further comprising a user equipment,
wherein the user equipment is arranged to simultaneously receive at least one positioning reference signals on a first frequency part and on a second frequency part; and
wherein the user equipment is arranged to receive at least one transmission and reception delay at the transmission/reception point for the downlink positioning reference signals on the first frequency part and on the second frequency part,
wherein the user equipment uses the at least one transmission and reception delay to process a time of arrival or a direction arrival estimation of the downlink positioning reference signals from the first frequency part and second frequency part.

38. The apparatus of claim 1,
wherein the first entity is arranged to transmit at least one reference signals at different time instants using a plurality of different transmission filters,
wherein the first entity is arranged to provide the transmission and reception delay information for each transmission filter,
wherein each transmission and reception delay information is associated with a timestamp,
wherein the processor circuit is arranged to receive at least one measurement report(s),
wherein the at least one measurement report(s) comprises measurements of the at least one reference signal(s) transmitted by the first entity,
wherein the at least one measurement report(s) comprises time information about the time instants of the measurements of the reference signals,
wherein the processor circuit is arranged to map the transmission and reception delay information received from the first entity to the at least one measurement reports received from the at least one second entity(s) using the timestamps associated with the transmission and reception delay information and the time information.

39. The apparatus of claim 1,
wherein the first entity, is arranged to receive at least one reference signals at different time instants using a plurality of different reception filters,
wherein the first entity is arranged to the transmission and reception delay information for each reception filter used,
wherein each transmission and reception delay information is associated with a timestamp,
wherein the processor circuit is arranged to receive from the first entity at least one measurement report(s),
wherein the at least one measurement report(s) comprise measurements of the at least one reference signals received by the first entity,
wherein the at least one measurement reports comprises time information about the time instants of the measurements of the reference signals,
wherein the processor circuit is arranged to map the transmission and reception delay information received from the first entity to the at least one measurement reports received from the at least one second entity(s) using the timestamps associated with the transmission and reception delay information and the time information.

40. The apparatus of claim 1,
wherein the circuit operates in using a data, wherein the data is selected from the group consisting of angle of arrival, angle of departure, time of arrival, time of flight, time difference of arrival, enhanced Cell ID, and NR-Multi-RTT.

41. The apparatus of claim 1,
wherein the user device comprises at least one of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side circuit (RSU), or a building, or any other item or device provided with network connectivity enabling the item/device to communicate using the communication network, e.g., a sensor or actuator, or any other item or device provided with network connectivity enabling the item/device to communicate using a sidelink the communication network, e.g., a sensor or actuator, or any sidelink capable network entity, and
wherein the radio access network entity base station comprises at least one of the following: a macro cell base station, or a small cell base station, or a central circuit of a base station, or a distributed circuit of a base station, or a road side circuit (RSU), or a UE, or a group leader (GL), or a relay or a remote radio head, or an AMF, or an MME, or an SMF, or a core network entity, or mobile edge computing (MEC) entity, or a network slice as in the NR or 5G core context, or any transmission/reception point enabling an item or a device to communicate using the communication network,
wherein the item or device is provided with network connectivity to communicate using the communication network.

42. (canceled)

43. A method comprising:
determining a position of a first entity in a communication network using at least one position measurement (s),
wherein the at least one position measurement(s) are between a position of the first entity and at least one second entities,
wherein each of the first entity and at least one second entity(s) comprise at least one antenna(s),
wherein the at least at least one antenna(s) are arranged to transmit and/or receive a radio signal for the position measurement; and
determining the position of the first entity using a transmission reception reference point, transmission reception reference point, and transmission and reception delay, transmission and reception delay, information of the radio signal at the at least one antenna(s) of the first entity and/or at least one antenna(s) of the at least one second entities,
wherein the transmission and reception delay information comprises information on the signal delay between the transmission reception reference point and a baseband circuit.

44. A method comprising:
transmitting a transmission reception position, transmission reception reference point, and transmission and reception delay delay, information of the radio signal using the at least one antenna (s),
wherein the transmission and reception delay information comprises information on the signal delay between the transmission reception reference point and a baseband circuit.

45. A method for operating an apparatus for a communication network,
wherein the apparatus comprises at least one antenna(s),
wherein the at least one antenna(s) is arranged to receive a radio signal from at least one radio access network entities and/or user devices of the communication network, the method comprising:
receiving a transmission reception position, transmission reception reference point, and transmission and reception delay, transmission and reception delay, information of the radio signal transmitted by at least one antenna (s) of the respective radio access network entities and/or user devices,
wherein the transmission and reception delay information comprises information on the signal delay between the transmission reception reference point and a baseband circuit; and
performing a position determining process using the at least one received transmission reception reference point and the transmission and reception delay information,
wherein the determining process is arranged to determine the position of the apparatus using the received transmission reception reference point and the transmission and reception delay information.

46. A computer program stored on a non-transitory medium, wherein the computer program when executed on a processor performs the method as claimed in claim 43.

47. A computer program stored on a non-transitory medium, wherein the computer program when executed on a processor performs the method as claimed in claim 44.

48. A computer program stored on a non-transitory medium, wherein the computer program when executed on a processor performs the method as claimed in claim 45.
